(19) United States
(12) Patent Application Publication
(10) Pub. No.: US 2004/0214919 A1
(43) Pub. Date: Oct. 28, 2004

(54) Ink composition and ink jet recording method using the same

(75) Inventors: Kenji Ikeda, Shizuoka-ken (JP); Takahiro Ishizuka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/762,543

(22) Filed: Jan. 23, 2004

(30) Foreign Application Priority Data
Jan. 23, 2003 (JP) 2003-14469

(51) Int. Cl. C03C 17/00; C09D 5/00

(52) U.S. Cl. 523/160; 523/161

(57) ABSTRACT

The present invention provides an ink composition comprising a fine color particle dispersion containing an oil-soluble dye, a hydrophobic polymer and a high-boiling point organic solvent, wherein the glass transition temperature (Tg) of the hydrophobic polymer is 40° C. or more. An average particle diameter of the color fine particles is preferably 0.01 to 0.5 μm and has a specific gravity of 0.9 to 1.2. A solubility of water in the high boiling point organic solvent at 25° C. is preferably 4 g or less. Also, the invention provides an ink jet recording method comprising a step of forming an image by discharging the ink composition onto an ink image receiving material and a step of fusing the fine color particles contained in the ink composition on the ink image receiving material by at least one of heat and pressure.

### CROSS-REFERENCE TO RELATED APPLICATIONS

This application claims benefit of and priority to Japanese Patent Application No. 2003-14469, filed on Jan. 23, 2003, which is incorporated herein by reference in its entirety for all purposes.

### BACKGROUND OF THE INVENTION

1. Field of the Invention

The present invention relates to an ink composition containing an oil-soluble dye and to an ink jet recording method using the ink composition. Particularly, the present invention relates to an ink composition that does not cause nozzle clogging and exhibits improved ink discharging characteristics, and to an ink jet recording method using said ink composition.

2. Description of the Related Art

Methods of forming images, especially full-color images, using recording systems such as ink jet recording systems, electrostatic transfer systems, and sublimation type thermal transfer systems have been spreading rapidly. These recording systems aim to achieve the qualities of silver salt photography, and developments have been made to these systems to raise, most importantly, color reproducibility, image density, glossiness, water resistance, weather resistance and the like to levels close to those of silver salt color photography.

In the aforementioned ink jet recording system, liquid micro-droplets are sprayed on the basis of various working principles so as to adhere to a recording medium such as paper) thereby recording images, characters and the like.

This ink jet recording system provides easily attainable high-speed and low-sound operation, multi-coloring development made easy, and high flexibility/elasticity of recorded patterns. Furthermore, developing and fixing are unnecessary in ink jet recording systems. For these reasons, the ink jet recording system has become the system of choice in many types of image-recording devices, including information processing devices.

Moreover, images formed by a multicolor ink jet recording system are on par with images obtained by multicolor printing based on plate-making or color photographic systems. Particularly when the number of copies is small, prints can be produced at costs that are lower than usual multicolor printing, hence, the ink jet recording system has come to be widely applied in the full-color image recording field.

In response to increasing demand, improvements in ink jet recording have been made in recording devices and recording methods so as to provide better recording characteristics and attain high-speed, high-definition, full-color printing. There is also a demand for inks and recording media that have high grade and diverse characteristics. Various improvements have been made in order to realize qualities that surpass those of silver salt color photography.

Conventionally, water-soluble dyes are mainly used as the ink colorants in ink jet recording systems because aqueous liquid mediums are used. Although certain fundamental requirements are satisfied by use of these water-soluble dyes, there is still much room for improvement. For example, when printed products recorded with water-soluble dyes are stored for long periods of time, these products tend to fade and discolor because water-soluble dyes possess inferior light fastness and ozone resistance.

Also, since these dyes are water-soluble, water resistance is often a problem. Specifically, images recorded with water-soluble dyes tend to blur or stain when contacted with water. There is also a problem in that satisfactory image glossiness cannot be obtained and for these reasons, images created in ink jet recording systems are inferior to silver salt color photographs.

In order to solve the above problems, recording mediums produced in the following manner have been proposed: a porous layer made from thermoplastic high-molecular material is disposed on a base material and after printing, the porous layer is dissolved by heat and pressure action to densify the medium (see, for example, Japanese Patent Application Laid-Open (JP-A) No. 58-136482 and the specification of U.S. Pat. No. 5,374,475).

In the meantime, methods have been proposed in which a dye is encapsulated in a urethane or polyester dispersion particle (see, for example, JP-A Nos. 58-45272, 6-340835, 7-268254, 7-268257 and 7-268260). However, inks obtained with these methods do not provide satisfactory color tone, color reproducibility, or fading resistance. Also, depending on the resin, printing aptitude can be unsatisfactory, and clogging caused by coalescences of dispersed particles tends to occur. Moreover, when printing on photographic paper, anti-abrasion characteristics against, for example, an eraser is insufficient.

For these reasons, it is clear that an ink composition containing a fine color particle dispersion for use in ink jet recording has yet to be proposed that provides good handling while being odorless and safe. Further, an ink composition has yet to developed that contains small dispersion particles while excelling in dispersion and preservation stability, providing ink that does not clog nozzle tips, exhibits high jetting/discharging stability, and is not dependent on the type of paper. There is a demand for an ink composition that can achieve the above and enable high quality recording at high density while excelling in color developing ability, color tone (hue), ink penetrability even on photographic paper, water resistance, image preservation, and resistance to abrasion after printing.

### SUMMARY OF THE INVENTION

The present invention solves the aforementioned current problems and achieves the following object. Specifically, the invention provides a color fine particle dispersion which has high handling characteristics, odorless characteristics and safety, is preferably used in applications such as writing aqueous ink, aqueous printing ink and information recording ink, is sufficiently decreased in the particle diameter of a dispersion particle and is superior in the dispersion stability and preserving stability of a dispersion.

Also, the invention provides an ink jet recording ink which is suitable to a thermal, piezoelectric, electric field or acoustic ink jet systems, has high handling characteristics, odorless characteristics and safety, is sufficiently decreased in the particle diameter of a dispersion particle and is superior in the dispersion stability and preserving stability of a dispersion, is reduced in the occurrence of clogging at the tip of a nozzle, is independent on paper and therefore has excellent color developing ability and color tone (hue) when printing on paper selected optionally, is superior in ink penetrability into photographic quality paper, has high water resistance, light fastness, particularly ozone resistance, image preserving characteristics and anti-scratching characteristics after printing and enables high quality recording at a high density.

Moreover, the invention provides an ink jet recording method which ensures high handling characteristics, odorless characteristics and safety, ravels out jetting inferiors caused by the clogging at the head of a nozzle, is independent on paper and therefore has excellent color developing ability and color tone (hue) when printing on paper selected optionally, is superior in ink penetrability into photographic quality paper, ensures high water resistance, light fastness, particularly ozone resistance, image preserving characteristics and anti-scratching characteristics after printing and enables high quality recording at a high density.

Accordingly, the invention provides an ink composition comprising a color fine particle dispersion containing an oil-soluble dye, a hydrophobic polymer, and a high-boiling point organic solvent, wherein a glass transition temperature (Tg) of the hydrophobic polymer is 40° C. or more.

In one embodiment, the invention provides the ink composition , wherein the average particle diameter of the color fine particles is 0.01 to 0.5 μm and has a specific gravity of 0.9 to 1.2.

In another embodiment, the invention provides the ink composition, wherein the solubility of water in the high boiling point organic solvent at 25° C. is 4 g or less.

Further, the invention provides an ink jet recording method comprising:

discharging the ink composition against an ink image receiving material; and

fusing fine color particles contained in the ink composition onto the ink image receiving material by at least one of heat and pressure.

### DETAILED DESCRIPTION OF THE INVENTION

An ink composition according to the present invention comprises a color fine particle dispersion containing at least an oil-soluble dye, a hydrophobic polymer and a high-boiling point organic solvent, wherein a glass transition temperature (Tg) of the hydrophobic polymer is 40° C. or more.

The color fine particle dispersion is a colored fine particle dispersion containing at least an oil-soluble dye, at least one hydrophobic polymer and at least one high-boiling point organic solvent. The oil-soluble dye and the hydrophobic polymer may be prepared using any method as far as they are compatible with each other.

For example, using a preparation method in which a solution containing an oil-soluble dye, a hydrophobic polymer and a water-insoluble high-boiling point organic solvent and according to the case, an auxiliary solvent is mixed with an aqueous medium to emulsify and disperse these components and then the auxiliary solvent is removed, a stable color fine particle dispersion according to the invention is obtained.

At this time, solutions are prepared by changing the types and amounts of the structural components in the solution and a sample of the color fine particle dispersion obtained by removing the auxiliary solvent from the solusions by evaporation or the like is examined, which makes it possible to estimate the compatibility, specific gravity and hardness of a desired color fine particle.

The term “aqueous medium” in this specification means water or a mixture of a small amount of a water miscible organic solvent and water to which additives such as a surfactant, a stabilizer and an antiseptic are added according to the need.

Oil-soluble Dye

First, the oil-soluble dye used in the invention will be explained.

The oil-soluble dye which is one of the components constituting the color fine particle dispersion of the invention means a dye which is substantially insoluble in water. To state specifically, it indicates a dye having a solubility (mass of a dye soluble in 100 g of water) of 1 g or less, preferably 0.5 g or less and more preferably 0.1 g or less in water at 25° C. Therefore, the oil-soluble dye means so-called water-insoluble pigments and oil-soluble dyes. Among them, oil-soluble dyes are preferable.

As the oil-soluble dye, those having a melting point of 200° C. or less are preferable, those having a melting point of 150° C. or less are more preferable and those having a melting point of 100° C. or less are still more preferable. The use of an oil-soluble dye having a low melting point suppress the precipitation of a dye crystal in the color fine particle dispersion and ink composition and therefore the preserving stability of the ink composition is improved.

In the color fine particle dispersion and ink composition of the invention, these oil-soluble dyes may be used either singly or by mixing several types. Also, colorants such as other water-soluble dyes, dispersion dyes and pigments may be contained according to the need to the extent that the effect of the invention is hindered.

Examples of oil-soluble dyes usable for the color fine particle dispersion and ink composition of the invention include anthraquinone type, naphthoquinone type, styryl type, indoaniline type, azo type, nitro type, cumarin type, methine type, porphyrin type, azaporphyrin type and phthalocyanine type dyes. It is to be noted that at least dyes of four colors including three primary colors, namely, yellow (Y), magenta (M) and cyan (C), and black are necessary to obtain a complete ink jet ink for full-color printing.

Among oil-soluble dyes usable in the invention, an optional one may be used as the yellow dye. Examples of the yellow dye include aryl or heteryl azo dyes containing phenols, naphthols, anilines, pyrazolones, pyridones or open-chain type active methylene compounds as a coupling component; azomethine dyes containing open-chain type active methylene compounds as a coupling component; methine dyes such as benzylidene dyes and monomethineoxonol dyes; and quinone type dyes such as naphthoquinone dyes and anthraquinone dyes. Examples of dye types other than the above may include quinophthalone dyes, nitro-nitroso dyes, acridine dyes and acridinone dyes.

Among oil-soluble dyes usable in the invention, an optional one may be used as the magenta dye. Examples of the magenta dye may include aryl or heteryl azo dyes containing phenols, naphthols and anilines as a coupling component; azomethine dyes containing pyrazolones or pyrazolotriazoles as a coupling component; methine dyes such as aryldene dyes, styryl dyes, merocyanine dyes and oxonol dyes; carbonium dyes such as diphenylmethane dyes, triphenylmethane dyes and xanthene dyes, quinone type dyes such as naphthoquinone, anthraquinone and anthrapyridone and condensed polycyclic dyes such as dioxazine dyes.

Among oil-soluble dyes usable in the invention, a desired one may be used as the cyan dye. Examples of the cyan dye may include indoaniline dyes, indophenol dyes, azomethine dyes containing pyrrolotriazoles as a coupling component; polymethine dyes such as cyanine dyes, oxonol dyes and merocyanine dyes; carbonium dyes such as diphenylmethane dyes, triphenylmethane dyes and xanthene dyes; phthalocyanine dyes; anthraquinone dyes; aryl or heterylazo dyes containing phenols, naphthols and anilines as a coupling component and indigo-thioindigo dyes.

Each of the above dyes may be those exhibiting each yellow, magenta or cyan color only after a part of chromophore is dissociated. The counter cation in this case may be an inorganic cation such as an alkali metal or ammonium or an organic cation such as pyridinium or a quaternary ammonium salt, or a polymer cation having these cations in its partial structure.

Preferable and specific examples of the oil-soluble dye among the above oil-soluble dyes include the following compounds, which, however, are not intended to be limiting of the invention.

For example, C.I. Solvent.Black 3, 7, 27, 29 and 34; C.I. Solvent.Yellow 14, 16, 19, 29, 30, 56, 82, 93 and 162; C.I. Solvent.Red 1, 3, 8, 18, 24, 27, 43, 49, 51, 72, 73, 109, 122, 132 and 218; C.I. Solvent.Violet 3; C.I. Solvent.Blue 2, 11, 25, 35, 38, 67 and 70; C.I. Solvent.Green 3 and 7; and C.I.

Solvent.Orange 2 are Preferable.

Among these dyes, Nubian Black PC-0850, Oil Black HBB, Oil Yellow 129, Oil Yellow 105, Oil Pink 312, Oil Red 5B, Oil Scarlet 308, Vali Fast Blue 2606, Oil Blue BOS (trade name, manufactured by Orient Chemical Industries, Ltd.), Aizen Spilon Blue GNH (trade name, manufactured by Hodogaya Chemical Co., Ltd.), Neopen Yellow 075, Neopen Mazenta SE 1378, Neopen Blue 808, Neopen Blue FF4012, Neopen Cyan FF4238 (trade name, manufactured by BASF Japan Ltd.) and the like are more preferable.

Also, in the invention, a dispersion dye may be used to the extent that it is dissolved in a water-non-miscible organic solvent. Preferable and specific examples of the dispersion dye include the following compounds, which, however, are not intended to be limiting of the invention.

For example, C.I. Disperse Yellow 5, 42, 54, 64, 79, 82, 83, 93, 99, 100, 119, 122, 124, 126, 160, 184:1, 186, 198, 199, 201, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; and C.I. Disperse Green 6:1 and 9 are preferable.

Among the aforementioned oil-soluble dyes, compounds (azo dyes) represented by the following formula (I) and compounds (azomethine dyes) represented by the following formula (II) are given as preferable examples. Azomethine dyes represented by the following formula (II) are known as the dyes produced by oxidation from couplers and developing agents in photographic materials.

Explanations will be furnished hereinbelow as to compounds represented by the following formulae (I) and (II). Compounds in which at least one group among each group represented by the formulae (I) and (II) falls in the preferable range shown below are preferable, compounds in which many more groups fall in the preferable range are more preferable and compounds in which all group falls in the preferable range are particularly preferable.

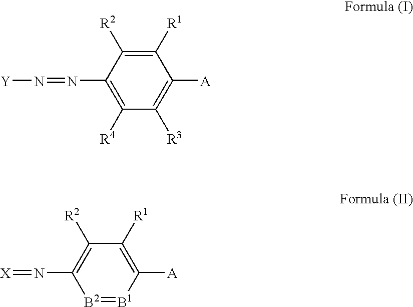

In the above formulae (I) and (II), R¹, R², R³ and R⁴ each independently represents a hydrogen atom, a halogen atom, an aliphatic group, an aromatic group, a heterocyclic group, a cyano group, a hydroxyl group, a nitro group, an amino group, an alkylamino group, an alkoxy group, an aryloxy group, an amide group, an arylamino group, a ureide group, a sulfamoylamino group, an alkylthio group, an arylthio group, an alkoxycarbonylamino group, a sulfonamide group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a sulfinyl group, a phosphoryl group, an acyl group, a carboxyl group or a sulfo grouphydroxyl group.

Among these groups, a hydrogen atom, halogen atom, aliphatic group, alkoxy group, aryloxy group, amide group, ureide group, sulfamoylamino group, alkoxycarbonylamino group and sulfonamide group are preferable as R².

In the above formulae (I) and (II), A represents —NR⁵R⁶ or a hydroxyl group. As A, —NR⁵R⁶ is desirable.

The above R⁵ and R⁵ each independently represents a hydrogen atom, an aliphatic group, an aromatic group or a heterocyclic group. Among these groups, a hydrogen atom, alkyl group and substituted alkyl group, aryl group and substituted aryl group are more preferable and a hydrogen atom, alkyl group having 1 to 18 carbon atoms and substituted alkyl groups having 1 to 18 carbon atoms are most preferable as each of the above R⁵ and R⁶. R⁵ and R⁶ may be combined with each other to form a ring.

In the above formula (II), B¹ represents ═C(R³)— or ═N—. B² represents —C(R⁴)═ or —N═. The case where B¹ and B² are not —N=simultaneously is preferable and the case where B¹ is ═C(R³)— and B² is —C(R⁴)═ is more preferable.

In the above formulae (I) and (II), at least one pair among pairs of R¹ and R⁵, R³ and R⁶ and R¹ and R² may respectively be combined with each other to form an aromatic ring or a heterocyclic ring.

In this specification, the aliphatic group means an alkyl group, substituted alkyl group, alkenyl group, substituted alkenyl group, alkinyl group, substituted alkinyl group, aralkyl group and substituted aralkyl group.

The above aliphatic group may be branched or cyclic. The number of carbons in the aliphatic group is preferably 1 to 20 and more preferably 1 to 18.

The aryl part of the aralkyl group or substituted aralkyl group is preferably a phenyl group or naphthyl group and more preferably a phenyl group.

Examples of the substituent of the alkyl part in the above substituted alkyl group, substituted alkenyl group, substituted alkinyl group and substituted aralkyl group include the same groups as the examples given as the substituent in R¹, R², R³ and R⁴.

Examples of the substituent of the aryl part in the above substituted aralkyl group include the same groups as the examples of the substituent in the following substituted aryl group.

In this specification, the aromatic group means an aryl group and substituted aryl group. As the aryl group, a phenyl group and naphthyl group are preferable and a phenyl group is more preferable.

The aryl part in the substituted aryl group is the same as in the case of the above aryl group.

Examples of the substituent in the substituted aryl group include the same groups as the examples given as the substituent in R¹, R², R³ and R⁴.

In the above formula (I), Y represents an unsaturated heterocyclic group. As Y, a five-membered or six-membered unsaturated heterocyclic ring is preferable. The hetero ring may be condensed with an aliphatic ring, aromatic ring or other hetero ring. Examples of the heteroatom may include N, O and S.

As the aforementioned unsaturated hetero ring, for example, a pyrazole ring, imidazole ring, thiazole ring, isothiazole ring, thiadiazole ring, thiophene ring, benzothiazole ring, benzoxazole ring, benzoisothiazole ring, pyrimidine ring, pyridine ring and quinoline ring are preferable. Also, the unsaturated heterocyclic group may have a substituent exemplified in the case of the aforementioned R¹, R², R³ and R⁴.

In the formula (II), X represents a residue of a color photographic coupler. As the coupler, the following couplers are preferable.

Examples of a yellow coupler include couplers represented by the formulae (I) and (II) in U.S. Pat. Nos. 3,933,501, 4,022,620, 4,326,024, 4,401,752 and 4,248,961, Japanese Patent Application Publication (JP-B) No. 58-10739, U.K. patent Nos. 1,425,020 and 1,476,760, U.S. Pat. Nos . 3,973,968, 4,314,023 and 4,511,649 and EP Nos. 249,473A and 502,424A, couplers (especially, Y-28 on page 18) represented by the formulae (1) and (2) in EP No. 513,496A, a coupler represented by the formula (I) in claim 1 of EP No. 568,037A, a coupler represented by the formula (I) on line 45 to line 55 of Column 1 in U.S. Pat. No. 5,066,576, a coupler represented by the formula (I) in Paragraph No. 0008 in JP-A No. 4-274425, a coupler (especially, D-35 on page 18) described in claim 1 on page 40 in EP No. 498,381A1, a coupler (especially, Y-1 (page 17) and Y-54 (page 41)) represented by the formula (Y) on page 4 in EP No. 447, 969A1 and a coupler (especially, II-17 and 19 (Column 17) and II-24 (Column 19)) represented by the formulae (II) to (IV) on page 36 to page 58 of Column 7 in U.S. Pat. No. 4,476,219.

Examples of a magenta coupler include the couplers described in U.S. Pat. Nos. 4,310,619 and 4,351,897, EP No. 73,636, U.S. Pat. No. 3,061,432 and 3,725,067, Research Disclosure Nos. 24220 (June, 1984) and 24230 (June, 1984), JP-A Nos. 60-33552, 60-43659, 61-72238, 60-35730, 55-118034 and 60-185951, U.S. Pat. Nos. 4,500,630, 4,540,654 and 4,556,630, WO88/04795, JP-A No. 3-39737 (L-57 (page 11, right lower column), L-68 (page 12, right lower column) and L-77 (page 13, right lower column), Ep No. 456,257 ([A-4]-63 (page 134), [A-4]-73, -75 (page 139)), EP No. 486,965 (M-4, -6 (page 26), (M-7) (page 27)), EP No. 571,959A (M-45 (page 19)), JP-A No. 5-204106 ((M-1) (page 6)) and JP-A No. 4-362631 (M-22 in Paragraph No. 0237).

Examples of a cyan coupler include the couplers described in U.S. Pat. Nos. 4,052,212, 4,146,396, 4,228,233, 4,296, 200, EP No. 73,636, JP-A No. 4-204843 (CX-1, 3, 4, 5, 11, 12, 14 and 15 (page 14 to page 16); JP-A No. 4-43345 (C-7, 10 (page 35), 34, 35 (page 37), (I-1), (I-17) (page 42 to page 43) ); and JP-A No. 6-67385 (couplers represented by the formula (Ia) or (Ib) in claim 1).

Besides the above, the couplers described in JP-A No. 62-215272 (page 91), JP-A No. 2-33144 (page 3 and page 30) and EP 355,660A (pages 4, 5, 45 and 47) are also useful.

Among dyes represented by the formula (I), dyes represented by the following formula (III) are particularly preferable as the magenta dyes.

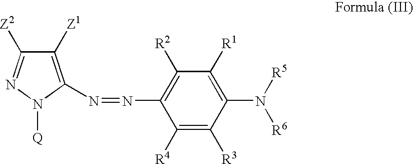

In the formula (III), Z¹ represents an electron attractive group having a Hammett's substituent constant σₚ of 0.20 or more. As Z¹, electron attractive groups having σₚ of 0.30 or more and 1.0 or less are preferable. Preferable and specific examples of the substituent may include electron attractive substituents which will be described later. Among these substituents, an acyl group having 2 to 12 carbon atoms, alkyloxycarbonyl group having 2 to 12 carbon atoms, nitro group, cyano group, alkylsulfonyl group having 1 to 12 carbon atoms, arylsulfonyl group having 6 to 18 carbon atoms, carbamoyl group having 1 to 12 carbon atoms and alkyl halide group having 1 to 12 carbon atoms are more preferable, a cyano group, alkylsulfonyl group having 1 to 12 carbon atoms and arylsulfonyl group having 6 to 18 carbon atoms are still more preferable and a cyano group is particularly preferable.

R¹ and R⁶ have the same meanings as those in the formula (I).

Z² represents a hydrogen atom, an aliphatic group or an aromatic group.

Q represents a hydrogen atom, an aliphatic group, an aromatic group or a heterocyclic group. As Q, groups consisting of a nonmetal atomic group necessary for forming a five- to eight-membered ring are preferable and an aromatic group or a heterocyclic group is more preferable. The above five- to eight-membered ring may be substituted and may be a saturated ring or may have an unsaturated bond. As the nonmetal atomic group, a nitrogen atom, oxygen atom, sulfur atom or carbon atom is preferable.

Preferable examples of the five- to eight-membered ring include a benzene ring, cyclopentane ring, cyclohexane ring, cycloheptane ring, cyclooctane ring, cyclohexene ring, pyridine ring, pyrimidine ring, pyrazine ring, pyridazine ring, triazine ring, imidazole ring, benzoimidazole ring, oxazole ring, benzoxazole ring, oxane ring, sulfolane ring and thian ring. When these rings have substituents, these substituents are preferably groups exemplified as the above R¹ to R⁴.

It is to be noted that preferable structures of the dyes represented by the formula (III) are described in Japanese Patent Application No. 2000-220649.

Among dyes represented by the formula (II), dyes represented by the following formula (IV) are particularly preferable as the magenta dyes.

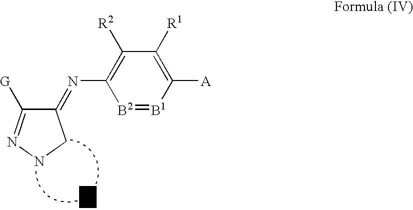

In the formula (IV), G represents a hydrogen atom, an aliphatic group, an aromatic group, a heterocyclic group, a cyano group, an alkoxy group, an aryloxy group, an alkylthio group, an arylthio group, an ester group, an amino group, a carbamoyl group, a sulfonyl group, a sulfamoyl group, a ureide group, a urethane group, an acyl group, an amide group or a sulfonamide group.

Also, R¹, R², A, B¹ and B² have the same meanings as those in the formula (II) and their preferable ranges are also the same as those in the formula (II).

L represents an atomic group forming a five- or six-membered nitrogen-containing hetero ring, wherein the atomic group forming the nitrogen-containing hetero ring may be substituted with at least one among an aliphatic group, aromatic group, heterocyclic group, cyano group, alkoxy group, aryl group, oxy group, alkylthio group, arylthio group, ester group, amino group, carbamoyl group, sulfonyl group, sulfamoyl group, ureide group, urethane group, acyl group, amide group and sulfonamide group, or may further form a condensed ring with another ring.

As A in the dyes represented by the formula (IV), —NR⁵R⁶ is preferable. As L, those forming a five-membered nitrogen-containing hetero ring are preferable. For example, an imidazole ring, triazole ring, tetrazole ring and the like are preferable as the five-membered nitrogen-containing hetero ring.

As examples of compounds used for magenta dyes among the dyes represented by the formulae (I) and (II), the compounds (M-1 to M-70) described in JP-A No. 2002-10361 are preferably given: however, these examples are not intended to be limiting of the invention.

Compounds usable in the invention are, though not limited to, those described in Japanese Patent Application Nos. 11-365187, 11-365190 and 2000-220649 besides the above-exemplified compounds.

The dyes represented by the formula (III) in the invention may be synthesized on reference to the methods described in Japanese Patent Application No. 2000-220649 and the JP-A No. 55-16156.

The dyes represented by the formula (IV) in the invention may be synthesized on reference to the methods described in, for example, JP-A No. 4-126772, JP-B No. 7-94180 and Japanese Patent Application No. 2000-78491.

As cyan dyes among the dyes represented by the formula (II), pyrrolotriazole azomethine dyes represented by the following formula (V) are particularly preferable.

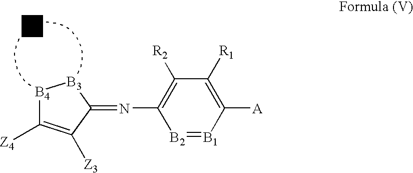

In the formula (V), A, R¹, R², B¹ and B² have the same meanings as those in the formula (II) and their preferable ranges are the same as those in the formula (II).

Z³ and Z⁴ respectively have the same meaning as G in the formula (IV). Z³and Z⁴ may be combined with each other to form a cyclic structure.

M is an atomic group capable of forming a 1,2,4-triazole ring condensed with the five-membered ring of the formula (V), wherein at least one of the two atoms B³ and B⁴ is a nitrogen atom and the other is a carbon atom.

Further, among the pyrrolotriazole azomethine dyes represented by the (V), those in which Z³ is an electron attractive group having a Hammett's substituent constant σₚ of 0.30 or more have sharp absorption and are therefore preferable, those in which Z³ is an electron attractive group having a Hammett's substituent constant σₚ of 0.45 or more are more preferable and those in which Z³ is an electron attractive group having a Hammett's substituent constant σₚ of 0.60 or more are particularly preferable.

And, those in which the sum of the Hammett's substituent constants σₚ of Z³ and Z⁴ is 0.70 or more exhibit an excellent hue as a cyan color and are therefore most preferable.

It is to be noted that although pyrrolotriazole azomethine dyes represented by the (V) may be used as a magenta dye by changing the substituent, they are preferably used as cyan dyes.

Here, the Hammett's substituent constant σₚ used in this specification will be explained.

The Hammett's rule is an empirical rule proposed by L. P. Hammett in 1935 to discuss the influence of a substituent on the reaction and equilibrium of benzene derivatives quantitatively. The propriety of this rule is widely admitted today.

The substituent constant based on the Hammett's rule include a σₚ and a σₘ and these σₚ and σₘ are found in usual published documents. These values are described in detail in, for example, “Lange's Handbook of Chemistry” edited by J. A. Dean, 12^{th} edition (1979) (McGraw-Hill) and “Area of Chemistry” special issue, No. 122, pp.96-103, (1979) (Nankodo Co., Ltd.).

It is needles to say that each substituent is limited or explained by the Hammett's substituent constant σₚ; however, this means that it is not limited to only the substituents whose Hammett's constant σₚ are found as known values in the aforementioned published documents, but even if its value is unknown on literature, it includes substituents whose Hammett's constant σₚ will be within the range of the Hammett's rule when measured based on the Hammett's rule.

Also, although in the compounds represented by the formulae (I) to (V) and following formulae (M-I) and (M-II) according to the invention, those which are not benzene derivatives are included, σₚ is used as the standard showing the electronic effect of a substituent irrespective of the substitution position. Accordingly, in the invention, the σₚ is used in this meaning.

Examples of electron attractive groups having a Hammett's substituent constant σₚ of 0.60 or more include a cyano group, nitro group and alkylsulfonyl group (e.g., a methanesulfonyl group, arylsulfonyl group (e.g., a benzenesulfonyl group)).

Examples of electron attractive groups having a Hammett's substituent constant σₚ of 0.45 or more include, besides the above, an acyl group (e.g., an acetyl group), alkoxycarbonyl group (e.g., dodecyloxycarbonyl group), aryloxycarbonyl group (e.g., m-chlorophenoxycarbonyl), alkylsulfinyl group (e.g., n-propylsulfinyl), arylsulfinyl group (e.g., phenylsulfinyl) sulfamoyl group (e.g., N-ethylsulfamoyl and N,N-dimethylsulfamoyl) and alkyl halide (e.g., trifluoromethyl)

Examples of electron attractive groups having a Hammett's substituent constant σₚ of 0.30 or more include, besides the above, an acyloxy group (e.g., acetoxy), carbamoyl group (e.g., N-ethylcarbamoyl and N,N-dibutylcarbamoyl), alkoxy halide group (e.g., trifluoromethyloxy), aryloxy halide group (e.g., pentafluorophenyloxy), sulfonyloxy group (e.g., a methylsulfonyloxy group), alkylthio halide group (e.g., difluoromethylthio), aryl group substituted with two or more electron attractive groups having an σₚ of 0.15 or more (e.g., 2,4-dinitrophenyl and pentachlorophenyl) and hetero ring (e.g., 2-benzoxazolyl, 2-benzothiazolyl, 1-phenyl-2-benzimidazolyl).

Examples of electron attractive groups having a σₚ of 0.20 or more include, besides the above, halogen atoms.

Preferable examples of compounds used as cyan dyes among the pyrrolotriazole azomethine dyes in the invention include the compounds (C-1 to C-9) described in Japanese Patent Application No. 2002-10361. However, the invention is not limited to these compounds.

Examples of dyes usable in the invention include the exemplified compounds described in the specification of Japanese Patent Application No. 11-365188; however, these compounds are not intended to be limiting of the invention.

As yellow dyes used as the oil-soluble dye in the invention, compounds (dyes) represented by the following formula (Y-I) are preferable.

A—N═N—B Formula (Y-I)

In the formula (Y-I), A and B each independently represents a heterocyclic group which may be substituted. The hetero ring is preferably hetero rings constituted of a five- or six-membered ring, may be a monocyclic structure or a polycyclic structure obtained by condensation of two or more rings and may be an aromatic hetero ring or non-aromatic hetero ring. As the heteroatom constituting the hetero ring, a nitrogen atom, oxygen atom and sulfur atom are preferable.

As the hetero ring represented by A in the formula (Y-I) 5-pyrazolone, pyrazole, oxazolone, isooxazolone, balbituric acid, pyridone, rhodanine, pyrazolidinedione, pyrazolopyridone, meldramic acid and condensed hetero rings obtained by further condensing these hetero rings with a hydrocarbon aromatic ring or a hetero ring are preferable. Among these hetero rings, 5-pyrazolone, 5-aminopyrazole, pyridone and pyrazoloazoles are preferable and 5-aminopyrazole, 2-hydroxy-6-pyridone and pyrazolotriazole are particularly preferable.

Preferable examples of the hetero ring represented by B in the formula (Y-I) include pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzoimidazole, triazole, oxazole, isooxazole, benzooxazole, thiazole, benzothiazole, isothiazole, benzoisothiazole, thiadiazole, benzoisooxazole, pyrrolidine, piperidine, piperazine, imidazolidine and thiazoline. Among these hetero rings, pyridine, quinoline, thiophene, benzothiophene, pyrazole, imidazole, benzoimidazole, triazole, oxazole, isooxazole, benzooxazole, thiazole, benzothiazole, isothiazole, benzoisothiazole, thiadiazole and benzoisooxazole are preferable and quinoline, thiophene, pyrazole, thiazole, benzooxazole, benzoisooxazole, isothiazole, imidazole, benzothiazole and thiadiazole are more preferable and pyrazole, benzothiazole, benzoxazole, imidazole, 1,2,4-thiadiazole and 1,3,4-thiadiazole are particularly preferable.

Examples of the substituent with which the aforementioned A and B are substituted include a halogen atom, alkyl group, cycloalkyl group, aralkyl group, alkenyl group, alkinyl group, aryl group, heterocyclic group, cyano group, hydroxyl group, nitro group, alkoxy group, aryloxy group, silyloxy group, heterocyclic oxy group, acyloxy group, carbamoyloxy group, alkoxycarbonyloxy group, aryloxycarbonyloxy group, amino group, acylamino group, aminocarbonylamino group, alkoxycarbonylamino group, aryloxycarbonylamino group, sulfamoylamino group, alkyl or arylsulfonylamino group, mercapto group, alkylthio group, arylthio group, heterocyclic thio group, sulfamoyl group, alkyl or arylsulfinyl group, alkyl or arylsulfonyl group, acyl group, aryloxycarbonyl group, alkoxycarbonyl group, carbamoyl group, imide group, phosphino group, phosphinyl group, phosphinyloxy group, phosphinylamino group and silyl group.

Among the dyes represented by the formula (Y-I), dyes represented by the following formulae (Y-II), (Y-III) and (Y-IV) are more preferable.

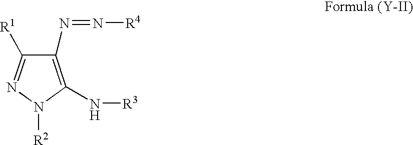

In the formula (Y-II), R¹ and R³ each independently represents a hydrogen atom, a cyano group, an alkyl group, a cycloalkyl group, an aralkyl group, an alkoxy group, an alkylthio group, an arylthio group, an aryl group or an ionic hydrophilic group. R² represents a hydrogen atom, an alkyl group, a cycloalkyl group, an aralkyl group, a carbamoyl group, an acyl group, an aryl group or a heterocyclic group. R⁴ represents a heterocyclic group.

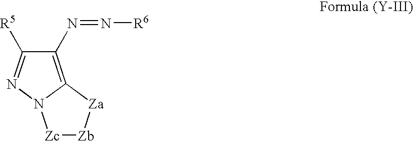

In the formula (Y-III), R⁵ represents a hydrogen atom, a cyano group, an alkyl group, a cycloalkyl group, an aralkyl group, an alkoxy group, an alkylthio group, an arylthio group, an aryl group or an ionic hydrophilic group. Za represents —N═, —NH— or C(R¹¹)═ and Zb and Zc each independently represents —N═, —NH— or C(R¹¹)═, wherein R¹¹ represents a hydrogen atom or a nonmetal substituent. R⁶ represents a heterocyclic group.

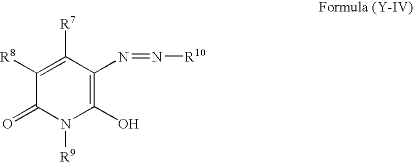

In the formula (Y-IV), R⁷ and R⁹ each independently represents a hydrogen atom, a cyano group, an alkyl group, a cycloalkyl group, an aralkyl group, an aryl group, an alkylthio group, arylthio group, an alkoxycarbonyl group, a carbamoyl group or an ionic hydrophilic group. R⁸ represents a hydrogen atom, a halogen atom, an alkyl group, an alkoxy group, an aryl group, an aryloxy group, a cyano group, an acylamino group, a sulfonylamino group, an alkoxycarbonylamino group, a ureide group, an alkylthio group, an arylthio group, an alkoxycarbonyl group, a carbamoyl group, a sulfamoyl group, a sulfonyl group, an acyl group, an alkylamino group, an arylamino group, a hydroxyl group or an ionic hydrophilic group. R¹⁰ represents a heterocyclic group.

The substituents represented by R¹, R², R³, R⁵, R⁷, R⁸ and R⁹, in the formulae (Y-II), (Y-III) and (Y-IV) will be hereinafter explained in detail.

The alkyl group represented by R¹, R², R³, R⁵, R⁷, R⁸ or R⁹ includes alkyl groups having substituents and unsubstituted alkyl groups.

As the alkyl group, alkyl groups having 1 to 20 carbon atoms are preferable. Examples of the aforementioned substituent include a hydroxyl group, alkoxy group, cyano group, halogen atom and ionic hydrophilic group.

Preferable examples of the alkyl group include methyl, ethyl, butyl, isopropyl, t-butyl, hydroxyethyl, methoxyethyl, cyanoethyl, trifluoromethyl, 3-sulfopropyl and 4-sulfobutyl.

The cycloalkyl group represented by R¹, R², R³, R⁵, R⁷, R⁸ or R⁹ includes cycloalkyl groups having substituents and unsubstituted cycloalkyl groups.

As the cycloalkyl group, cycloalkyl groups having 5 to 12 carbon atoms are preferable. Examples of the aforementioned substituent include an ionic hydrophilic group.

Preferable examples of the cycloalkyl group include cyclohexyl.

The aralkyl group represented by R¹, R², R³, R⁵, R⁷, R⁸ or R⁹ includes aralkyl groups having substituents and unsubstituted aralkyl groups.

As the aralkyl group, aralkyl groups having 7 to 20 carbon atoms are preferable. Examples of the aforementioned substituent include an ionic hydrophilic group.

Preferable examples of the aralkyl group include benzyl and 2-phenethyl.

The aryl group represented by R¹, R², R³, R⁵, R⁷ or R⁹ includes aryl groups having substituents and unsubstituted aryl groups.

As the aryl group, aryl groups having 6 to 20 carbon atoms are preferable. Examples of the aforementioned substituent include an alkyl group, alkoxy group, halogen atom, alkylamino group and ionic hydrophilic group.

Preferable examples of the aryl group include phenyl, p-tolyl, p-methoxyphenyl, o-chlorophenyl and m-(3-sulfopropylamino)phenyl.

The alkylthio group represented by R¹, R², R³, R⁵, R⁷, R⁸ or R⁹ includes alkylthio groups having substituents and unsubstituted alkylthio groups.

As the alkylthio group, alkylthio groups having 1 to 20 carbon atoms are preferable. Examples of the aforementioned substituent include an ionic hydrophilic group.

Preferable examples of the alkylthio group include methylthio and ethylthio.

The arylthio group represented by R¹, R², R³, R⁵, R⁷, R⁸ or R⁹ includes arylthio groups having substituents and unsubstituted arylthio groups.

As the arylthio group, arylthio groups having 6 to 20 carbon atoms are preferable. Examples of the aforementioned substituent include an alkyl group and ionic hydrophilic group.

Preferable examples of the arylthio group include a phenylthio group and p-tolylthio.

The heterocyclic group represented by R² is preferably five- or six-membered hetero rings, which may be further condensed with rings. As the heteroatom constituting the hetero ring, a nitrogen atom, sulfur atom and oxygen atom are preferable. Also, the hetero cyclic group may be an aromatic hetero ring or non-aromatic hetero ring. The hetero ring may be further substituted. Preferable examples of the substituent include the same substituents as those of an aryl group which will be explained later. Preferable examples of the hetero ring include six-membered nitrogen-containing aromatic hetero rings, among which triazine, pyrimidine and phthalazine are particularly preferable.

Preferable examples of the halogen atom represented by R⁸ include a fluorine atom, chlorine atom and bromine atom.

The alkoxy groups represented by R¹, R³, R⁵ or R⁸ include alkoxy groups having a substituent and unsubstituted alkoxy groups.

As the alkoxy group, alkoxy groups having 1 to 20 carbon atoms are preferable. Examples of the substituent include a hydroxyl group and ionic hydrophilic group.

Preferable examples of the alkoxy group include methoxy, ethoxy, isopropoxy, methoxyethoxy, hydroxyethoxy and 3-carboxypropoxy.

The aryloxy group represented by R⁸ include aryloxy groups having a substituent and unsubstituted aryloxy groups.

As the aryloxy group, aryloxy groups having 6 to 20 carbon atoms are preferable and examples of the substituent include an alkoxy group and ionic hydrophilic group.

Preferable examples of the aryloxy group include phenoxy, p-methoxyphenoxy and o-methoxyphenoxy.

The acylamino group represented by R⁸ include acylamino groups having a substituent and unsubstituted acylamino groups.

As the acylamino group, acylamino groups having 2 to 20 carbon atoms are preferable and examples of the substituent include an ionic hydrophilic group.

Preferable examples of the acylamino group include acetamide, propionamide, benzamide and 3,5-disulfobenzamide.

The sulfonylamino group represented by R⁸ include sulfonylamino groups having a substituent and unsubstituted sulfonylamino groups.

As the sulfonylamino group, sulfonylamino groups having 1 to 20 carbon atoms are preferable.

Preferable examples of the sulfonylamino group include methylsulfonylamino and ethylsulfonylamino.

The alkoxycarbonylamino group represented by R⁸ include alkoxycarbonylamino groups having a substituent and unsubstituted alkoxycarbonylamino groups.

As the alkoxycarbonylamino group, alkoxycarbonylamino groups having 2 to 20 carbon atoms are preferable and examples of the substituent include an ionic hydrophilic group.

Preferable examples of the alkoxycarbonylamino group include ethoxycarbonylamino.

The ureide group represented by R⁸ include ureide groups having a substituent and unsubstituted ureide groups.

As the ureide group, ureide groups having 1 to 20 carbon atoms are preferable and examples of the substituent include an alkyl group and aryl group.

Preferable examples of the ureide group include 3-methylureide, 3,3-dimethylureide and 3-phenylureide.

The alkoxycarbonyl group represented by R⁷, R⁸ or R⁹ include alkoxycarbonyl groups having a substituent and unsubstituted alkoxycarbonyl groups.

As the alkoxycarbonyl group, alkoxycarbonyl groups having 2 to 20 carbon atoms are preferable and examples of the substituent include an ionic hydrophilic group.

Preferable examples of the alkoxycarbonyl group include methoxycarbonyl and ethoxycarbonyl.

The carbamoyl group represented by R², R⁷, R⁸ or R⁹ include carbamoyl groups having a substituent and unsubstituted carbamoyl groups. Examples of the substituent include an alkyl group.

Preferable examples of the carbamoyl group include a methylcarbamoyl group and dimethylcarbamoyl group.

The sulfamoyl group represented by R⁸ include sulfamoyl groups having a substituent and unsubstituted sulfamoyl groups. Examples of the substituent include an alkyl group.

Preferable examples of the sulfamoyl group include a dimethylsulfamoyl group and di-(2-hydroxyethyl)sulfamoyl group.

Preferable examples of the sulfonyl group represented by R⁸ include methanesulfonyl and phenylsulfonyl.

The acyl group represented by R²or R⁸ include acyl groups having a substituent and unsubstituted acyl groups. As the acyl group, acyl groups having 1 to 20 carbon atoms are preferable. Examples of the substituent include an ionic hydrophilic group.

Preferable examples of the acyl group include acetyl and benzoyl.

The amino group represented by R⁸ include amino groups having a substituent and unsubstituted amino groups. Examples of the substituent include an alkyl group, aryl group and heterocyclic group.

Preferable examples of the amino group include methylamino, diethylamino, anilino and 2-chloroanilino.

The heterocyclic group represented by R⁴, R⁶ or R¹⁰ is the same as the heterocyclic group which is represented by B of the aforementioned formula (Y-I) and may have a substituent. Preferable examples, more preferable examples and particularly preferable examples are also the same as above.

Examples of the substituent include an ionic hydrophilic group, alkyl group having 1 to 12 carbon atoms, aryl group, alkyl or arylthio group, halogen atom, cyano group, sulfamoyl group, sulfonamino group, carbamoyl group and acylamino group, wherein the alkyl group and aryl group may further have a substituent.

In the above formula (Y-III), Za represents —N═, —NH— or C(R¹¹)═. Zb and Zc each independently represents —N═ or C(R¹¹)═R¹¹ represents a hydrogen atom or a nonmetal substituent. As the nonmetal substituent represented by R¹¹, a cyano group, cycloalkyl group, aralkyl group, aryl group, alkylthio group, arylthio group or ionic hydrophilic group is preferable. Each of the above substituents has the same meaning as each substituent represented by R¹ and preferable examples are also the same. Examples of the skeleton of the heterocyclic ring contained in the above formula (Y-III) and consisting of two five-membered rings will be shown below.

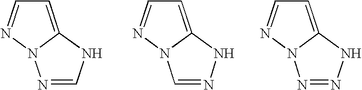

In the case where each substituent explained above may further have a substituent, examples of the substituent may include substituents with which the hetero rings A and B in the above formula (Y-I) may be substituted.

Specific examples of the dye represented by the formula (Y-I) preferably include the compounds (Y-101 to Y-155) described in Japanese Patent Application No. 2002-10361; however, these compounds are not intended to be limiting of the invention. These compounds may be synthesized on reference to JP-A Nos. 2-24191 and 2001-279145.

Moreover, as oil-soluble dyes used preferably as the oil-soluble dye in the invention, compounds (hereinafter referred to as “azo dye” as the case may be) represented by the following formula (M-I) are preferable. The compounds represented by the formula (M-I) in the invention will be explained below.

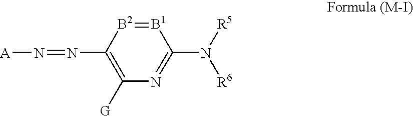

In the formula (M-I), A represents a residue of a five-membered heterocyclic diazo component (A—NH₂).

As regards B¹ and B², when B¹ represents ═CR¹—, B² represents —CR²═ or any one of them represents a nitrogen atom and the other represents ═CR^{1— or —CR}²═.

R⁵and R⁶ each independently represents a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group or a sulfamoyl group. Each group may further have a substituent.

G, R¹and R² each independently represents a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group substituted with an alkyl group, aryl group or heterocyclic group, an acylamino group, a ureide group, a sulfamoylamino group, an alkoxycarbonylamino group, an aryloxycarbonylamino group, an alkylarylsulfonylamino group, an arylsulfonylamino group, an aryloxycarbonylamino group, a nitro group, an alkylthio group, an arylthio group, an alkylsulfonyl group, an arylsulfonyl group, an alkylsulfinyl group, an arylsulfinyl group, a sulfamoyl group, a sulfo group or a heterocyclic thio group. Each group may be substituted.

Also, R¹ and R⁵ or R⁵ and R⁶ may be combined with each other to form a five- or six-membered ring.

The compound represented by the above formula (M-I) in the invention will be explained in detail.

In the formula (M-I), A represents a residue of a five-membered heterocyclic diazo component (A—NH₂). Examples of the heteroatom of the five-membered ring may include N, O and S. A nitrogen-containing five-membered ring is preferable and the hetero ring may be condensed with an aliphatic ring, aromatic ring or other hetero rings.

Preferable examples of the hetero ring of A may include a pyrazole ring, imidazole ring, thiazole ring, isothiazole ring, thiadiazole ring, benzothiazole ring, benzoxazole ring and benzoisothiazole ring. Each heterocyclic ring may further have a substituent. Among these hetero rings, pyrazole rings, imidazole rings, isothiazole rings, thiadiazole rings and benzothiazole rings represented by the following formulae (M-a) to (M-f) are preferable.

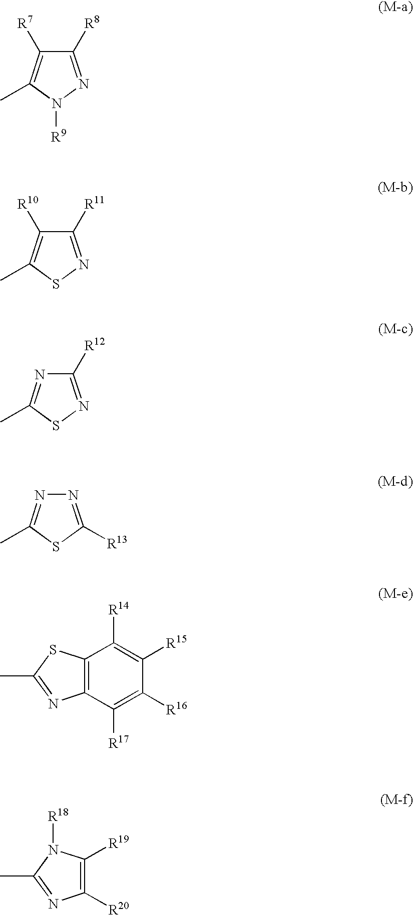

R⁷ to R²⁰ in the formulae (M-a) to (M-f) represent the same substituents as the substituents G, R¹ and R² which will be explained later.

Pyrazole rings and isothiazole rings represented by the formulae (M-a) and (M-b) respectively among the formulae (M-a) to (M-f) are preferable and pyrazole rings represented by the formula (M-a) are most preferable.

As regards B¹ and B², when B¹ represents ═CR¹—, B² represents —CR²═ or any one of them represents a nitrogen atom and the other represents ═CR¹— or —CR²═. The case where B¹ represents ═CR¹— and B² represents —CR²═is more preferable.

R⁵ and R⁶ each independently represents a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group or a sulfamoyl group. Each group may further have a substituent. Preferable examples of the substituent represented by R⁵ and R⁶ may include a hydrogen atom, aliphatic group, aromatic group, heterocyclic group, acyl group, alkylsulfonyl group and arylsulfonyl group. A hydrogen atom, aromatic group, heterocyclic group, acyl group, alkylsulfonyl group or arylsulfonyl group is more preferable. A hydrogen atom, aryl group or heterocyclic group is most preferable. Each group may have a substituent. Here, R⁵ and R⁶ are not a hydrogen atom at the same time.

G, R¹ and R² each independently represents a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group substituted with an alkyl group, aryl group or heterocyclic group, an acylamino group, a ureide group, a sulfamoylamino group, an alkoxycarbonylamino group, an aryloxycarbonylamino group, an alkylsulfonylamino group, an arylsulfonylamino group, a nitro group, an alkylthio group, an arylthio group, a heterocyclic thio group, an alkylsulfonyl group, an arylsulfonyl group, an alkylsulfinyl group, an arylsulfinyl group, a sulfamoyl group or a sulfo group. Each group may be substituted.

Preferable examples of the substituent represented by G include a hydrogen atom, halogen atom, aliphatic group, aromatic group, hydroxyl group, alkoxy group, aryloxy group, acyloxy group, heterocyclic oxy group, alkyl group, amino group substituted with an aryl group or heterocyclic group, acylamino group, ureide group, sulfamoylamino group, alkoxycarbonylamino group, aryloxycarbonylamino group, alkylthio group, arylthio group and heterocyclic thio group. A hydrogen atom, halogen atom, alkyl group, hydroxyl group, alkoxy group, aryloxy group, acyloxy group, amino group substituted with an alkyl group, aryl group or heterocyclic group or acylamino group is more preferable. Among these groups, a hydrogen atom, arylamino group and amide group are most preferable. Each group may further have a substituent.

Preferable examples of the substituent represented by R¹ and R² may include a hydrogen atom, alkyl group, alkoxycarbonyl group, carboxyl group, carbamoyl group and cyano group. Each group may have a substituent.

R¹ and R⁵ or R⁵ and R⁶ may be combined with each other to form a five- or six-membered ring.

When each substituent represented by A, R¹, R², R², R⁶ and G further has a substituent, examples of the substituent may include the substituents exemplified for G, R¹ and R².

The substituents represented by G, R¹ and R² will be explained hereinbelow in detail.

Examples of the halogen atom include a fluorine atom, chlorine atom and bromine atom.

The aliphatic group means an alkyl group, substituted alkyl group, alkenyl group, substituted alkenyl group, alkinyl group, substituted alkinyl group, aralkyl group and substituted aralkyl group. The aliphatic group may be branched or form a ring. The number of carbons of the aliphatic group is preferably 1 to 20 and more preferably 1 to 16. Each aryl part of the aralkyl group and substituted aralkyl group is preferably phenyl or naphthyl and particularly preferably phenyl. Examples of the aliphatic group may include a methyl group, ethyl group, butyl group, isopropyl group, t-butyl group, hydroxyethyl group, methoxyethyl group, cyanoethyl group, trifluoromethyl group, 3-sulfopropyl group, 4-sulfobutyl group, cyclohexyl group, benzyl group, 2-phenethyl group, vinyl group and allyl group.

In this specification, the aromatic group means an aryl group and substituted aryl group. The aryl group is preferably a phenyl group or naphthyl group and particularly preferably a phenyl group. The number of carbons of the aromatic group is preferably 6 to 20 and more preferably 6 to 16.

Examples of the aromatic group include a phenyl group, p-tolyl group, p-methoxyphenyl group, o-chlorophenyl group and m-(3-sulfopropylamino)phenyl group.

The heterocyclic group include heterocyclic groups having a substituent and unsubstituted heterocyclic groups. The hetero ring may be condensed with an aliphatic ring, aromatic ring or other hetero rings. As the heterocyclic ring, a five or six-membered heterocyclic group is preferable. Examples of the substituent include an aliphatic group, halogen atom, alkylsulfonyl group, arylsulfonyl group, acyl group, acylamino group, sulfamoyl group, carbamoyl group and ionic hydrophilic group. Examples of the heterocyclic group include a 2-pyridyl group, 2-thienyl group, 2-thiazolyl group, 2-benzothiazolyl group, 2-benzoxazolyl group and 2-furyl group.

Examples of the alkylsulfonyl group and arylsulfonyl group may include a methanesulfonyl group and phenylsulfonyl group respectively.

Examples of the alkylsulfinyl group and arylsulfinyl group may include a methanesulfinyl group and phenylsulfinyl group respectively.

The acyl group include acyl groups having a substituent and unsubstituted acyl groups. As the acyl group, acyl groups having 1 to 12 carbon atoms are preferable. Examples of the substituent include an ionic hydrophilic group. Examples of the acyl group include an acetyl group and benzoyl group.

The amino group include amino groups substituted with an alkyl group, aryl group or heterocyclic group. These alkyl group, aryl group and heterocyclic group may further have a substituent. Unsubstituted amino groups are not included. As the alkylamino group, an alkylamino group having 1 to 6 carbon atoms is preferable. Examples of the substituent include an ionic hydrophilic group. Examples of the alkylamino group include a methylamino group and diethylamino group.

The arylamino group include arylamino groups having a substituent and unsubstituted arylamino groups. As the arylamino group, arylamino groups having 6 to 12 carbon atoms are preferable. Examples of the substituent include a halogen atom and an ionic hydrophilic group. Examples of the arylamino group include an anilino group and 2-chloroanilino group.

The alkoxy group include alkoxy groups having a substituent and unsubstituted alkoxy groups. As the alkoxy group, alkoxy groups having 1 to 12 carbon atoms are preferable. Examples of the substituent include an alkoxy group, hydroxyl group and ionic hydrophilic group. Examples of the alkoxy group include a methoxy group, ethoxy group, isopropoxy group, methoxyethoxy group, hydroxyethoxy group and 3-carboxypropoxy group.

The aryloxy group include aryloxy groups having a substituent and unsubstituted aryloxy groups. As the aryloxy group, aryloxy groups having 6 to 12 carbon atoms are preferable. Examples of the substituent include an alkoxy group and ionic hydrophilic group. Examples of the aryloxy group include a phenoxy group, p-methoxyphenoxy group and o-methoxyphenoxy group.

The acylamino group include acylamino groups having a substituent. As the acylamino group, acylamino groups having 2 to 12 carbon atoms are preferable. Examples of the substituent include an ionic hydrophilic group. Examples of the acylamino group include an acetylamino group, propionylamino group, benzoylamino group, N-phenylacetylamino and 3,5-disulfobenzoylamino group.

The ureide group include ureide groups having a substituent and unsubstituted ureide groups. As the ureide group, ureide groups having 1 to 12 carbon atoms are preferable. Examples of the substituent include an alkyl group and aryl group. Examples of the ureide group include 3-methylureide group, 3,3-dimethylureide group and 3-phenylureide group.

The sulfamoylamino group include sulfamoylamino groups having a substituent and unsubstituted sulfamoylamino groups. Examples of the substituent include an alkyl group. Examples of the sulfamoylamino group include a N,N-dipropylsulfamoylamino group.

The alkoxycarbonylamino group include alkoxycarbonylamino groups having a substituent and unsubstituted alkoxycarbonylamino groups. As the alkoxycarbonylamino group, alkoxycarbonylamino groups having 2 to 12 carbon atoms are preferable. Examples of the substituent include an ionic hydrophilic group. Examples of the alkoxycarbonylamino group include an ethoxycarbonylamino group.

The alkylsulfonylamino group or arylsulfonylamino group include alkyl or arylsulfonylamino groups having a substituent and unsubstituted alkyl or arylsulfonylamino groups. As the alkyl or arylsulfonylamino group, alkyl or arylsulfonylamino groups having 1 to 12 carbon atoms are preferable. Examples of the substituent include an ionic hydrophilic group. Examples of the alkyl or arylsulfonylamino group include a methanesulfonylamino group, N-phenylmethanesulfonylamino group, benzenesulfonylamino group and 3-carboxybenzenesulfonylamino group.

The carbamoyl group include carbamoyl groups having a substituent and unsubstituted carbamoyl groups. Examples of the substituent include an alkyl group. Examples of the carbamoyl group include a methylcarbamoyl group and dimethylcarbamoyl group.

The sulfamoyl group include sulfamoyl groups having a substituent and unsubstituted sulfamoyl groups. Examples of the substituent include an alkyl group. Examples of the sulfamoyl group include a dimethylsulfamoyl group and di-(2-hydroxyethyl)sulfamoyl group.

The alkoxycarbonyl group include alkoxycarbonyl groups having a substituent and unsubstituted alkoxycarbonyl groups. As the alkoxycarbonyl group, alkoxycarbonyl groups having 2 to 12 carbon atoms are preferable. Examples of the substituent include an ionic hydrophilic group. Examples of the alkoxycarbonyl group include a methoxycarbonyl group and ethoxycarbonyl group.

The acyloxy group include acyloxy groups having a substituent and unsubstituted acyloxy groups. As the acyloxy group, acyloxy groups having 1 to 12 carbon atoms are preferable. Examples of the substituent include an ionic hydrophilic group. Examples of the acyloxy group include an acetoxy group and benzoyloxy group.

The carbamoyloxy group include carbamoyloxy groups having a substituent and unsubstituted carbamoyloxy groups. Examples of the substituent include an alkyl group. Examples of the carbamoyloxy group include a N-methylcarbamoyloxy group.

The aryloxycarbonyl group include aryloxycarbonyl groups having a substituent and unsubstituted aryloxycarbonyl groups. As the aryloxycarbonyl group, aryloxycarbonyl groups having 7 to 12 carbon atoms are preferable. Examples of the substituent include an ionic hydrophilic group. Examples of the aryloxycarbonyl group include a phenoxycarbonyl group.

The aryloxycarbonylamino group include aryloxycarbonylamino groups having a substituent and unsubstituted aryloxycarbonylamino groups. As the aryloxycarbonylamino group, aryloxycarbonylamino groups having 7 to 12 carbon atoms are preferable. Examples of the substituent include an ionic hydrophilic group. Examples of the aryloxycarbonylamino group include a phenoxycarbonylamino group.

The alkyl, aryl or heterocyclic thio group include alkyl, aryl or heterocyclic thio groups having a substituent and unsubstituted alkyl, aryl or heterocyclic thio groups. As the alkyl, aryl or heterocyclic thio group, those having 1 to 12 carbon atoms are preferable. Examples of the substituent include an ionic hydrophilic group. Examples of the alkyl, aryl or heterocyclic thio group include a methylthio group, phenylthio group and 2-pyridylthio group.

Azo dyes particularly preferable in the invention are compounds represented by the following formula (M-II).

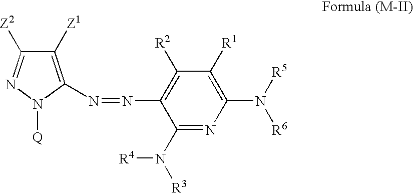

In the formula (M-II), Z¹ represents an electron attractive group having a Hammett's substituent constant σ₀ of 0.20 or more. As Z¹, electron attractive groups having σₚ of 0.30 to 1.0 are preferable. Preferable and specific examples of the substituent may include electron attractive substituents which will be described later. Among these substituents, an acyl group having 2 to 12 carbon atoms, alkyloxycarbonyl group having 2 to 12 carbon atoms, nitro group, cyano group, alkylsulfonyl group having 1 to 12 carbon atoms, arylsulfonyl group having 6 to 18 carbon atoms, carbamoyl group having 1 to 12 carbon atoms and alkyl halide group having 1 to 12 carbon atoms are more preferable, a cyano group, alkylsulfonyl group having 1 to 12 carbon atoms and arylsulfonyl group having 6 to 18 carbon atoms are still more preferable and a cyano group is most preferable.

R¹, R^{2, R}⁵ and R⁶ have the same meanings as those in the formula (M-I).

R³ and R⁴ each independently represents a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group or a sulfamoyl group. Among these groups, a hydrogen atom, aromatic group, heterocyclic group, acyl group, alkylsulfonyl group and arylsulfonyl group are preferable and a hydrogen atom, aromatic group and heterocyclic group are particularly preferable.

Z² represents a hydrogen atom, an aliphatic group, an aromatic group or a heterocyclic group.

Q represents a hydrogen atom, an aliphatic group, an aromatic group or a heterocyclic group. As Q, among these groups, groups consisting of a nonmetal atomic group necessary for forming a five- to eight-membered ring are preferable. The above five- to eight-membered ring may be substituted and may be a saturated ring or may have an unsaturated bond. Among these groups, an aromatic group and heterocyclic group are particularly preferable. Preferable examples of the nonmetal atom include a nitrogen atom, oxygen atom, sulfur atom or carbon atom. Specific examples of the five- to eight-membered ring include a benzene ring, cyclopentane ring, cyclohexane ring, cycloheptane ring, cyclooctane ring, cyclohexene ring, pyridine ring, pyrimidine ring, pyrazine ring, pyridazine ring, triazine ring, imidazole ring, benzoimidazole ring, oxazole ring, benzoxazole ring, thiazole ring, benzothiazole ring, oxane ring, sulfolane ring and thian ring.

Each group explained in the case of the formula (M-II) may further have a substituent. In the case where each of these groups further has a substituent, examples of the substituent include the substituents explained in the case of the formula (M-I) and the groups and ionic hydrophilic groups exemplified in the case of G, R¹ and R².

Particularly preferable combinations of substituents as the compounds represented by the formula (M-I) are as follows. (i) R⁵ and R⁶ are preferably a hydrogen atom, an alkyl group, an aryl group, a heterocyclic group, a sulfonyl group or an acyl group, more preferably a hydrogen atom, an aryl group, a heterocyclic group or a sulfonyl group and most preferably a hydrogen atom, an aryl group or a heterocyclic group, provided that R⁵ and R⁶ are not a hydrogen atom at the same time. (ii) G is preferably a hydrogen atom, a halogen atom, an alkyl group, a hydroxyl group, an amino group or an amide group, more preferably a hydrogen atom, a halogen atom, an amino group or an amide group and most preferably a hydrogen atom, an amino group or an amide group. (iii) A is preferably a pyrazole ring, an imidazole ring, an isothiazole ring, a thiadiazole ring or a benzothiazole ring, more preferably a pyrazole ring or an isothiazole ring and most preferably a pyrazole ring. (iv) B¹ and B² are respectively ═CR¹— or —CR²═, wherein R¹ and R² are respectively preferably a hydrogen atom, a halogen atom, a cyano group, a carbamoyl group, a carboxyl group, an alkyl group, a hydroxyl group or an alkoxy group and more preferably a hydrogen atom, a cyano group, a carbamoyl group or an alkoxy group.

As regards preferable combinations of substituents of the compound represented by the formula (M-I), compounds in which at least one of various substituents is the above preferable group are preferable, compounds in which many more substituents are the above preferable groups are more preferable and compounds in which all substituents are the above preferable groups are most preferable.

Preferable and specific examples of the dye represented by the formula (M-I) include the compounds (a-1 to a-27, b-1 to b-6, c-1 to c-3, d-1 to d-4 and e-1 to e-4) described in Japanese Patent Application No. 2002-10361; however, the invention is not limited to these compounds.

As the oil-soluble dye in the invention, compounds (hereinafter referred to as “phthalocyanine dye” as the case may be) represented by the following formula (C-I) are preferably used. The compounds represented by the formula (C-I) will be explained hereinbelow.

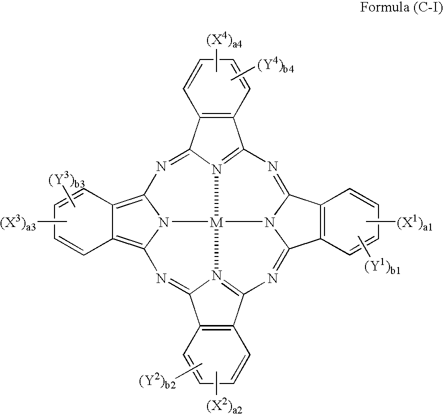

In the formula (C-I), X¹, X² X³ and X⁴ each independently represents —So-Z¹—, SO₂—Z¹ or —SO₂NR²¹R²².

Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group or a substituted or unsubstituted heterocyclic group, particularly preferably a substituted or unsubstituted alkyl group, a substituted or unsubstituted aryl group or a substituted or unsubstituted heterocyclic group and most preferably a substituted alkyl group, a substituted aryl group or a substituted heterocyclic group.

R²¹ and R²² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group or a substituted or unsubstituted heterocyclic group, particularly preferably a hydrogen atom, a substituted or unsubstituted alkyl group, a substituted or unsubstituted aryl group or a substituted or unsubstituted heterocyclic group and most preferably a hydrogen atom, a substituted alkyl group, a substituted aryl group or a substituted heterocyclic group. However, R²¹ and R²² are not both hydrogen atoms.

The substituted or unsubstituted alkyl groups represented by R²¹, R²²and Z¹ are preferably alkyl groups having 1 to 30 carbon atoms. Examples of the substituent include the same substituents that will be exemplified later in the case where Z¹, R²¹, R²², Y¹, Y², Y³ and Y⁴ may further have a substituent. Among these substituents, a hydroxyl group, alkoxy group, cyano group and halogen atom are preferable.

The cycloalkyl groups having a substituent or unsubstituted cycloalkyl groups represented by R²¹, R²² and Z¹ are preferably cycloalkyl groups having 5 to 30 carbon atoms. Examples of the substituent include the same substituents that will be exemplified later in the case where Z¹, R²¹, R²², Y¹, Y², Y³ and Y⁴ may further have a substituent. Among these substituents, a hydroxyl group, alkoxy group, cyano group and halogen atom are preferable.

The alkenyl groups having a substituent or unsubstituted alkenyl groups represented by R²¹, R²² and Z¹ are preferably alkenyl groups having 2 to-30 carbon atoms. Examples of the substituent include the same substituents that will be exemplified later in the case where Z¹, R²¹, R²², Y¹, Y², Y³ and Y⁴ may further have a substituent. Among these substituents, a hydroxyl group, alkoxy group, cyano group and halogen atom are preferable.

The aralkyl groups having a substituent or unsubstituted aralkyl groups represented by R²¹, R²² and Z¹ are preferably aralkyl groups having 7 to 30 carbon atoms. Examples of the substituent include the same substituents that will be exemplified later in the case where Z¹, R²¹, R²², Y¹, Y², Y³ and Y⁴ may further have a substituent. Among these substituents, a hydroxyl group, alkoxy group, cyano group and halogen atom are preferable.

Examples of the substituent of the aryl group represented by R²¹, R²² and Z¹ include the same substituents that will be exemplified later in the case where Z¹, R²¹, R²², Y¹, Y², Y³ and Y⁴ may further have a substituent. Preferable examples of the substituent include a halogen atom, heterocyclic group, cyano group, hydroxyl group, nitro group, carboxyl group, acylamino group, ureide group, sulfamoylamino group, alkyloxycarbonyl group, alkyloxycarbonylamino group, sulfonamide group, sulfamoyl group, carbamoyl group, sulfonyl group, acyloxy group, carbamoyloxy group, imide group, heterocyclic thio group, acyl group, sulfo group and quaternary ammonium group. Among these groups, a heterocyclic group, cyano group, carboxyl group, acylamino group, sulfonamide group, sulfamoyl group, carbamoyl group, sulfonyl group, imide group and acyl group are preferable, and a cyano group, carboxyl group, sulfamoyl group, carbamoyl group, sulfonyl group, imide group and acyl group are more preferable.

As the heterocyclic group represented by R²¹, R²² and Z¹, those having a five- or six-membered ring are preferable and the five- or six-membered ring may be further condensed. The heterocyclic group may be an aromatic heterocyclic ring or non-aromatic hetero ring.

The heterocyclic group represented by R²¹, R²² and Z¹ will be hereinafter exemplified in the form of a hetero ring in which substitution positions are omitted. There is no limitation to the substitution position. In the case of, for example, pyridine, it may be substituted at the second, third and fourth positions.

Examples of the hetero ring include pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isooxazole, benzisooxazole, pyrrolidine, piperidine, piperazine, imidazolidine and thiazoline. Among these hetero rings, aromatic heterocyclic groups are preferable. Preferable examples of these aromatic rings when exemplified in the same manner as the above case include pyridine, pyrazine, pyrimidine, pyridazine, triazine, pyrazole, imidazole, benzimidazole, triazole, thiazole, benzothiazole, isothiazole, benzisothiazole and thiadiazole. These rings may have a substituent.

Y¹, Y², Y³ and Y⁴ each independently represents a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureide group, a sulfamoylamino group, an alkylthio group, an arylthio group, an alkoxycarbonylamino group, a sulfonamide group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, phosphoryl group, an acyl group, a carboxyl group or a sulfo group, wherein each group may have a substituent.

Among these groups, a hydrogen atom, halogen atom, alkyl group, aryl group, cyano group, alkoxy group, amide group, ureide group, sulfonamide group, carbamoyl group, sulfamoyl group and alkoxycarbonyl group are preferable, a hydrogen atom, halogen atom and cyano group are preferable and a hydrogen atom is most preferable.

When Z¹, R²¹, R²², Y¹, Y², Y³ and Y⁴ are groups which may have a substituent, each may further have substituents exemplified below.

Examples of these substituents include halogen atoms (e.g., a chlorine atom and bromine atom), straight-chain or branched-chain alkyl groups having 1 to 30 carbon atoms, aralkyl groups having 7 to 30 carbon atoms, alkenyl groups having 2 to 30 carbon atoms, straight-chain or branched-chain alkinyl groups having 2 to 30 carbon atoms, straight-chain or branched-chain cycloalkyl groups having 3 to 30 carbon atoms and straight-chain or branched-chain cycloalkenyl groups having 3 to 30 carbon atoms, specifically, (e.g., methyl, ethyl, propyl, isopropyl, t-butyl, 2-methanesulfonylethyl, 3-phenoxypropyl, trifluoromethyl and cyclopentyl), aryl groups (e.g., phenyl, 4-t-butylphenyl and 2,4-di-t-amylphenyl), heterocyclic groups (e.g., imidazolyl, pyrazolyl, triazolyl, 2-furyl, 2-thienyl, 2-pyrimidinyl and 2-benzothiazolyl), cyano groups, hydroxyl groups, nitro groups, carboxy groups, amino groups, alkyloxy groups (e.g., methoxy, ethoxy, 2-methoxyethoxy and 2-methanesulfonylethoxy), aryloxy groups (e.g., phenoxy, 2-methylphenoxy, 4-t-butylphenoxy, 3-nitrophenoxy, 3-t-butyloxycarbamoylphenoxy and 3-methoxycarbamoyl), acylamino groups (e.g., acetamide, benzamide, 4-(3-t-butyl-4-hydroxyphenoxy)butaneamide), alkylaminogroups (e.g., methylamino,butylamino, diethylamino and methylbutylamino), anilino groups (e.g., phenylamino, 2-chloroanilino), ureide groups (e.g., phenylureide, methylureide and N,N-dibutylureide), sulfamoylamino groups (e.g., N,N-dipropylsulfamoylamino), alkylthio groups (e.g., methylthio, octylthio and 2-phenoxyethylthio), arylthio groups (e.g., phenylthio, 2-butoxy-5-t-octylphenylthio and 2-carboxyphenylthio), alkyloxycarbonylamino groups (e.g., methoxycarbonylamino), sulfonamide groups (e.g., methanesulfonamide, benzenesulfonamide and p-toluenesulfonamide), carbamoyl groups (e.g., N-ethylcarbamoyl and N,N-dibutylcarbamoyl), sulfamoyl groups (e.g., N-ethylsulfamoyl, N,N-dipropylsulfamoyl and N-phenylsulfamoyl), sulfonyl groups (e.g., methanesulfonyl, octanesulfonyl, benzenesulfonyl and toluenesulfonyl), alkyloxycarbonyl groups (e.g., methoxycarbonyl and butyloxycarbonyl), heterocyclic oxy groups (e.g., 1-phenyltetrazole-5-oxy and 2-tetrahydropyranyloxy), azo groups (e.g., phenylazo, 4-methoxyphenylazo, 4-pivaloylaminophenylazo and 2-hydroxy-4-propanoylphenylazo), acyloxy groups (e.g., acetoxy), carbamoyloxy groups (e.g., N-methylcarbamoyloxy and N-phenylcarbamoyloxy), silyloxygroups (e.g., trimethylsilyloxy and dibutylmethylsilyloxy), aryloxycarbonylamino groups (e.g., phenoxycarbonylamino), imide groups (e.g., N-succinimide and N-phthalimide), heterocyclic thio groups (e.g., 2-benzothiazolylthio, 2,4-di-phenoxy-1,3,5-triazole-6-thio and 2-pyridylthio), sulfinyl groups (e.g., 3-phenoxypropylsulfinyl), phosphonyl groups (e.g., phenoxyphosphonyl, octyloxyphosphonyl and phenylphosphonyl) aryloxycarbonyl groups (e.g., phenoxycarbonyl), acyl groups (e.g., acetyl, 3-phenylpropanoyl and benzoyl) and ionic hydrophilic groups (e.g., a carboxyl group, sulfo group and quaternary ammonium group).

a¹ to a⁴ and b¹ to b⁴ denote the number of substituents of X¹ to X⁴ and Y¹ to Y⁴ respectively, a¹ to a⁴respectively denote an integer from 0 to 4 and b¹ to b⁴respectively denote an integer from 0 to 4, provided that the sum of a¹ to a⁴ is 2 or more. Here, when a¹ to a⁴ and b⁴ to b⁴ each denote an integer of 2 or more, a plurality of X¹s to X⁴s and Y¹s to Y⁴s may respectively be the same or different.

a¹ and b¹ respectively denote an integer from 0 to 4 and satisfy the following relation: a¹+b¹=4. A particularly preferable combination of a¹ and b¹ is obtained when a¹ denotes 1 or 2 and b¹ denotes 3 or 2 and a most preferable combination of a¹ and b¹ is obtained when a¹ denotes 1 and b¹ denotes 3.

a² and b² respectively denote an integer from 0 to 4 and satisfy the following relation: a²+b²=4. A particularly preferable combination of a² and b² is obtained when a² denotes 1 or 2 and b² denotes 3 or 2 and a most preferable combination of a² and b² is obtained when a² denotes 1 and b² denotes 3.

a³ and b³ respectively denote an integer from 0 to 4 and satisfy the following relation: a³+b³=4. A particularly peferable combination of a³ and b³ is obtained when a³ denotes 1 or 2 and b³ denotes 3 or 2 and a most preferable combination of a³ and b³ is obtained when a³ denotes 1 and b³ denotes 3.

a⁴ and b⁴ respectively denote an integer from 0 to 4 and satisfy the following relation: a⁴+b⁴=4. A particularly preferable combination of a⁴ and b⁴ is obtained when a⁴ denotes 1 or 2 and b⁴ denotes 3 or 2 and a most preferable combination of a⁴ and b⁴ is obtained when a⁴ denotes 1 and b⁴ denotes 3.

M denotes a hydrogen atom, a metal element or its oxide, hydroxide or halide.

Preferable examples of M include a hydrogen atom, and Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb and Bi as metal atoms, VO and GeO as oxides, Si(OH)₂, (OH)₂ and Sn(OH)₂ as hydroxides and AlCl, SiCl₂, VCl, VCl₂, VOCl, FeCl, GaCl and ZrCl as halides. Among these materials, Cu, Ni, Zn and Al are particularly preferable and Cu is most preferable.

Also, Pc (phthalocyanine ring) may form a dimer (e.g., Pc-M-L-M-Pc) or a trimer through L (divalent connecting group) In this case, Ms may be the same or different.

The divalent connecting group represented by L is preferably an oxy group (—O—), thio group (—S—), carbonyl group (—CO—), sulfonyl group (—SO₂—), imino group (—NH—) or methylene group (—CH₂—).

A particularly preferable combination as the compound represented by the formula (C-I) is as follows.

It is particularly preferable that X¹ to X⁴ be respectively —SO₂—Z¹ or —SO₂NR²¹R>.

Z¹s are respectively preferably a substituted or unsubstituted alkyl group, a substituted or unsubstituted aryl group or a substituted or unsubstituted heterocyclic group. Among these groups, a substituted alkyl group, substituted aryl group and substituted heterocyclic group are most preferable.

R²¹ and R²² are respectively preferably a hydrogen atom, a substituted or unsubstituted alkyl group, a substituted or unsubstituted aryl group or a substituted or unsubstituted heterocyclic group. Among these groups, a hydrogen atom, substituted alkyl group, substituted aryl group and substituted heterocyclic group are most preferable.

As Y¹ and Y⁴, a hydrogen atom, halogen atom, alkyl group, aryl group, cyano group, alkoxy group, amide group, ureide group, sulfonamide group, carbamoyl group, sulfamoyl group, alkoxycarbonyl group, carboxyl group and sulfo group are preferable, a hydrogen atom, halogen atom, cyano group, carboxyl group and sulfo group are particularly preferable and a hydrogen atom is most preferable.

a¹ to a⁴ respectively denote an integer of preferably 1 or 2 and particularly preferably 1. b¹ to b⁴respectively denote an integer of preferably 3 or 2 and particularly preferably 3.

M represents a hydrogen atom or a metal element or its oxide, hydroxide or halide, particularly preferably Cu, Ni, Zn or Al and most preferably Cu.

As regards preferable combinations of substituents of the compound represented by the formula (C-I), compounds in which at least one of various substituents is the above preferable group are preferable, compounds in which many more substituents are the above preferable groups are more preferable and compounds in which all substituents are the above preferable groups are most preferable.

Among the compounds represented by the formula (C-I), compounds having the structure represented by the following formula (C-II) are more preferable.

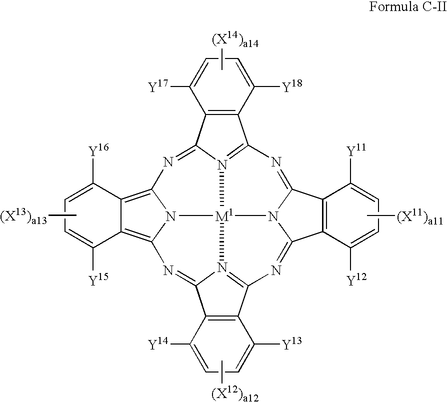

In the formula (C-II), X¹¹ to X¹⁴ and Y¹¹ to Y¹⁸ have the same meanings as X¹ to X⁴ and Y⁴ to Y⁴ respectively. Preferable examples are also the same. Also, M¹ has the same meaning as M in the formula (C-I) and preferable examples are also the same.

Specifically, X¹¹, X¹², X¹³ and X¹⁴ in the formula (C-II) each independently represents —SO—Z¹¹, —SO₂—Z¹¹ or —SO₂NR²³R²⁴.

Z¹¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group or a substituted or unsubstituted heterocyclic group.

R²³ represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group or a substituted or unsubstituted heterocyclic group. R²⁴ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group or a substituted or unsubstituted heterocyclic group.

Y¹¹, Y¹², Y¹³, Y¹⁴, Y¹⁵, Y¹⁶, Y¹⁷ and Y¹⁸ each independently represents a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureide group, a sulfamoylamino group, an alkylthio group, an arylthio group, an alkoxycarbonylamino group, a sulfonamide group, a carbamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a phosphoryl group, an acyl group, a carboxyl group or a sulfo group. Each group may further have a substituent.

a¹¹ to a¹⁴ respectively denote the number of substituents of X¹¹ to X¹⁴ and an integer from 0 to 2, but all of a¹¹ to a¹⁴ are not 0 at the same time. When a¹¹ to a¹⁴ respectively denote 2, two X¹¹s to X¹⁴s may be respectively the same or different.

M¹is a hydrogen atom, a metal atom or its oxide, hydroxide or halide.

In the above formula (C-II), a¹¹ to a¹⁴ respectively denote an integer of 1 or 2 and fall in the range satisfying the following equation: 4≦a¹¹+a¹²+a¹³+a¹⁴≦8, preferably satisfying the following equation: 4≦a¹¹+a¹²+a¹³+a¹⁴≦6 and most preferably satisfying the following condition: a¹¹=a¹²=a¹³=a¹⁴=1.

Among the compounds represented by the formula (C-II), particularly preferable combinations of substituents are as follows.

It is particularly preferable that X¹¹ to X¹⁴ be respectively —SO₂—Z¹¹ or —SO₂NR²³R²⁴.

Z¹¹ s are respectively preferably a substituted or unsubstituted alkyl group, a substituted or unsubstituted aryl group or a substituted or unsubstituted heterocyclic group. Among these groups, substituted alkyl groups, substituted aryl groups and substituted heterocyclic groups are most preferable.

R²³s are respectively preferably a hydrogen atom, a substituted or unsubstituted alkyl group, a substituted or unsubstituted aryl group or a substituted or unsubstituted heterocyclic group. Among these groups, a hydrogen atom, substituted alkyl group, substituted aryl group and substituted heterocyclic group are most preferable.

R²⁴ s are respectively preferably a substituted or unsubstituted alkyl group, a substituted or unsubstituted aryl group or a substituted or unsubstituted heterocyclic group. Among these groups, a substituted alkyl group, a substituted aryl group and a substituted heterocyclic group are most preferable.

Y¹¹ to Y¹⁸ are respectively preferably a hydrogen atom, a halogen atom, an alkyl group, an aryl group, a cyano group, an alkoxy group, an amide group, a ureide group, a sulfonamide group, a carbamoyl group, a sulfamoyl group or an alkoxycarbonyl group, particularly preferably a hydrogen atom, a halogen atom or a cyano group and most preferably a hydrogen atom.

a¹¹ to a¹⁴ are respectively preferably 1 or 2 and it is particularly preferable that all of a¹¹ to a¹⁴ be 1.

M¹ represents a hydrogen atom or a metal element or its oxide, hydroxide or halide, particularly preferably Cu, Ni, Zn or Al and most preferably Cu.

As regards preferable combinations of substituents of the compound represented by the formula (C-II), compounds in which at least one of various substituents is the above preferable group are preferable, compounds in which many more substituents are the above preferable groups are more preferable and compounds in which all substituents are the above preferable groups are most preferable.

The compound represented by the formula (C-I) is generally a mixture of analogues which differ in the introduced positions and the number of the substituents Rn (n=1 to 4) and Yq (q=1 to 4) inevitably due to its synthetic method. Many of these analogous mixtures are expressed by averaging them statistically. The invention is based on the finding that when these analogous mixtures are classified into three types, a specific mixture is particularly preferable.

In the invention, a mixture of phthalocyanine type dye analogues which are the compounds represented by the formulae (C-I) and (C-II) is classified into the following three types on the basis of substitution position to define.

(1) β-position substitution type: (phthalocyanine type dyes having specific substituents at the 2nd and/or 3rd positions, 6th and/or 7th positions, 10th and/or 11th positions or 14th and/or 15th positions).

(2) α-position substitution type: (phthalocyanine type dyes having specific substituents at the 1st and/or 4th positions, 5th and/or 8th positions, 9th and/or 12th positions or 13th and/or 16th positions).

(3) α,β-positions mixed substitution type: (phthalocyanine type dyes having specific substituents at the 1st to 16th positions irregularly).

When explaining phthalocyanine type dye derivatives differing in structure (particularly, substitution position) in this specification, the aforementioned β-position substitution type, α-position substitution type and α,β-positions mixed substitution type will be used.

The phthalocyanine derivatives used in the invention may be synthesized using, for example, the methods described or cited in Shirai & Kobayashi “Phthalocyanine-Chemistry and Function-”, published by Industrial Publishing & Consulting, Inc., (p.1 to p.62) and C. C. Leznoff & A. B. P. Lever, “Phthalocyanines-Properties and Applications”, published by VHC Publishers, Inc., (p.1 to p.54) or combinations of similar methods.

The compound represented by the formula (C-I) in the invention may be synthesized from an unsubstituted phthalocyanine compound through sulfonation, sulfonyl-chlorination and amidation reactions as described in each publication of WO00/17275, WO00/08103, WO00/08101, WO98/41853 and JP-A No. 10-36471. In this case, not only the sulfonation probably takes place at any position of a phthalocyanine nucleus but also it is hard to control the number of positions to be sulfonated. Therefore, when introducing a sulfo group in such a reaction condition, the position and number of sulfo groups which have been introduced into a product cannot be specified, always resulting in the production of a mixture of compounds differing in the number of substituents and substitution position. Consequently, as the number of sulfamoyl groups with which a hetero ring is substituted and substitution positions are not specified when synthesizing the compound of the invention by using this mixture as starting material, the compound of the invention is obtained as the α,β-positions mixed substitution type including several compounds differing in the number of substituents and substitution positions.

As mentioned above, many electron attractive groups such as a sulfamoyl group are introduced into a phthalocyanine nucleus, oxidation potential becomes richer, improving ozone resistance. According to the above synthetic method, phthalocyanine dyes decreased in the number of electron attractive groups to be introduced, so that oxidation potential is poorer are inevitably intermingled. It is therefore preferable to use such a synthetic method as to suppress the production of compounds having poorer oxidation potential.

On the other hand, the compound represented by the formula (C-II) according to the invention can be derived from the compound obtained by reacting a phthalonitrile derivative (compound P) and/or a diiminoisoindoline derivative (compound Q) represented by the following formulae with a metal derivative represented by the following formula (C-III).

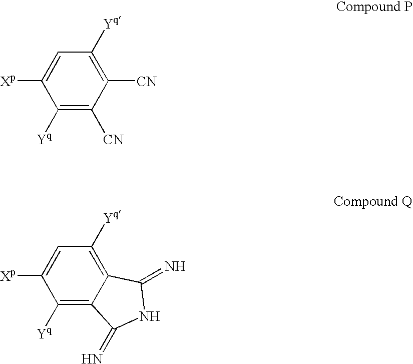

In the compounds P and Q, p denotes a number of 11 to 14 and q and q′ respectively denote a number of 11 to 18.

M—(Y)_{d} Formula (C-III)

In the formula (C-III), M has the same meaning as M in the compound represented by the formulae (C-I) and (C-II), Y represents a monovalent or divalent ligand such as a halogen atom, an acetic acid negative ion, acetyl acetonate or oxygen and d denotes an integer from 1 to 4.

Namely, according to the above synthetic method, desired substituents may be introduced in only specified numbers. Particularly, in the case of intending to introduce many electron attractive groups to raise oxidation potential in such a method like that of the invention, the above synthetic method is very superior as compared with the method of synthesizing the compound represented by the formula (C-I).

The compound thus obtained and represented by the formula (C-II) is a mixture of compounds represented by the following formulae (C-II-1) to (C-II-4) which compounds are isomers differing in each substitution position of X^{p}, namely, the β-position substitution type (phthalocyanine type dyes having specific substituents at the 2nd and/or 3rd positions, 6th and/or 7th positions, 10th and/or 11th positions or 14th and/or 15th positions).

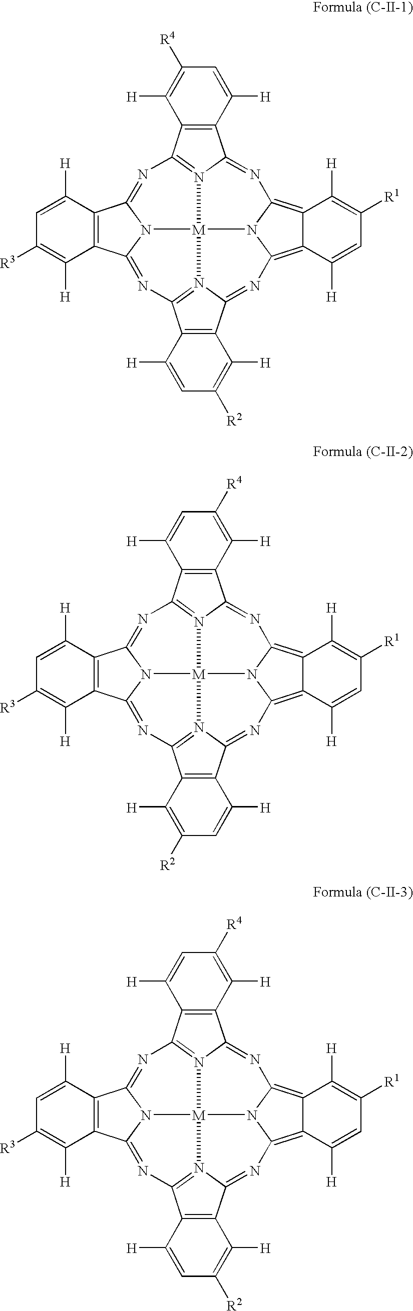

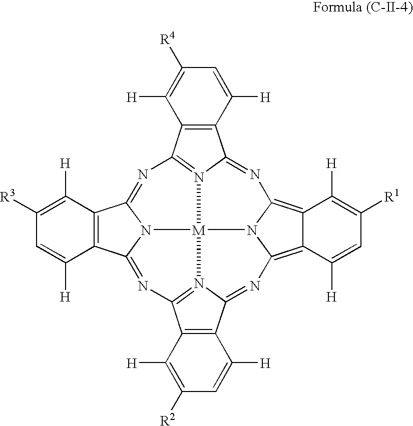

In the formulae (C-II-1) to (C-II-4), R¹ to R⁴ have the same meanings as (X¹¹) a¹¹ to (X¹⁴) a¹⁴ in the above formula (C-II).

It has been found in the invention that it is very important for improving fastness that oxidation potential is richer than 1.0 V (vs SCE) in all the substitution types. Among these substitution types, the β-position substitution type tends to be superior to the α,β-positions mixed substitution type in hue, light fastness and ozone gas resistance.

Specific and preferable examples of the dyes represented by the formula (C-I) or (C-II) include the compounds (C-101 to C-120) described in Japanese Patent Application No. 2000-10361: these compounds, however, are not intended to be limiting of the invention.

The compound represented by the formula (C-I) may be synthesized according the aforementioned patent. Also, the compound represented by the formula (C-II) may be synthesized using the methods described in each publication of Japanese Patent Application Nos. 2000-24352, 2000-47013, 2000-57063 and 2000-96610. The starting material, the dye intermediate and synthetic route are not limited by these patent applications.

The content of the oil-soluble dye to be used in an ink composition in the invention is preferably 0.05 to 50% by mass and more preferably 0.1 to 10% by mass based on the ink composition.

Hydrophobic Polymer

Next, the hydrophobic polymer used in the invention will be explained.

The hydrophobic polymer contained in the color fine particle dispersion and ink composition of the invention is a hydrophobic polymer having a glass transition temperature (Tg) of 40° C. or more. As the hydrophobic polymer, a high-molecular compound which is almost free from or is reduced in the absorption or adsorption of water is used. The high-molecular compound may be a natural polymer or synthetic polymer and is preferably a transparent or semitransparent colorless high-molecular compound. As regards the structure of the hydrophobic polymer, the hydrophobic polymer may be a polymer obtained by polymerization condensation, a polymer obtained by vinyl polymerization or a polymer obtained by a polymer reaction.

As the hydrophobic polymer to be used in the invention, a homopolymer of a desired monomer selected from a monomer group shown below as specific examples or a copolymer prepared by combining desired monomers may be used.

Also, no particular limitation is imposed on a usable monomer unit and any desired monomer unit may be used as far as it can be polymerized using a usual radical polymerization method.

Also, as the polymer obtained by the above polymerization, a polyester type polymer is preferable. Examples of the polyester type polymer include resins which are constituted of polyvalent carboxylic acids and polyhydric alcohols and obtained by condensation-polymerizing a single monomer or a combination of two or more monomers.

Any material may be used as the polyvalent carboxylic acids without any particular limitation. Examples of the polyvalent carboxylic acid include aromatic polyvalent carboxylic acids, aromatic oxycarboxylic acids, aliphatic dicarboxylic acids and alicyclic dicarboxylic acids such as terephthalic acid, isophthalic acid, orthophthalic acid, 1,5-naphthalenedicarboxylic acid, 2,6-naphthalenedicarboxylic acid, diphenic acid, sulfoterephthalic acid, 5-sulfoisophthalic acid, 4-sulfophthalic acid, 4-sulfonaphthalene-2,7-diarboxylic acid, 5[4-sulfophenoxy]isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid and pyromellitic acid. These acids may be used as metal salts, ammonium salts and the like.

Any material may be used as the polyhydric alcohols without any particular limitation. Examples of the polyhydric alcohols include aliphatic polyhydric alcohols, alicyclic polyhydric alcohols and aromatic polyhydric alcohols represented by ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerol, pentaerythritol, 1,4-cyclohexanediol, 1,4-cyclohexanedimethanol, spiro glycol, tricyclodecanediol, tricyclodecabedimethanol, methaxylene glycol, orthoxylene glycol, 1,4-phenylene glycol, bisphenol A, lactone type polyester and polyols.

Also, as the polyester resins obtained by polymerizing the aforementioned polyvalent carboxylic acids and polyhydric alcohols each singly or in combinations of two or more of each, those in which polar groups at the terminal of a high-molecular chain are sealed using a usually known compound capable of sealing terminals may be used.

As the aforementioned polymer obtained from a vinyl monomer, a homopolymer of a desired monomer selected from a monomer group shown below as specific examples or a copolymer prepared by optionally combining desired monomers may be used.

There is no particular limitation to a usable monomer unit and any desired material may be used as far as it can be polymerized by a usual radical polymerization method.

Specific examples of the vinyl monomer will be given in the following. However, these examples are not intended to be limiting of the invention.

Examples of the aforementioned vinyl monomer group include olefins, α,β-unsaturated carboxylic acids and their salts, α,β-unsaturated carboxylic acid derivatives, α,β-unsaturated carboxylic acid amides, styrenes and their derivatives, vinyl ethers, vinyl esters and other polymerizable monomers.

Examples of the olefins include ethylene, propylene, isoprene, butadiene, vinyl chloride, vinylidene chloride, 6-hydroxy-1-hexene, cyclopentadiene, 4-pentinic acid, methyl 8-nonenate, vinylsulfonic acid, trimethylvinylsilane, trimethoxyvinylsilane, butadiene, pentadiene, isoprene, 1,4-divinylcyclohexane and 1,2,5-trivinylcyclohexane.

Examples of the α,β-unsaturated carboxylic acid and its salts include acrylic acid, methacrylic acid, itaconic acid, maleic acid, sodium acrylate, ammonium methacrylate and potassium itaconate.

Examples of the α,β-unsaturated carboxylic acid derivatives include alkylacrylates (e.g., methylacrylate, ethylacrylate, n-butylacrylate, cyclohexylacrylate, 2-ethylhexylacrylate and n-dodecylacrylate), substituted alkylacrylates (e.g., 2-chloroethylacrylate, benzylacrylate, 2-cyanoethylacrylate and allylacrylate), alkylmethacrylates (e.g., methylmethacrylate, n-butylmethacrylate, 2-ethylhexylmethacrylate and n-dodecylmethacrylate), substituted alkylmethacrylates (e.g., 2-hydroxyethylmethacrylate, glycidylmethacrylate, glycerol monomethacrylate, 2-acetoxyethylmethacrylate, tetrahydrofurfurylmethacrylate, 2-methoxyethylmethacrylate, ω-methoxypolyethylene glycol methacrylate (polyoxyethylene addition mol number: 2 to 100), polyethylene glycol monomethacrylate (polyoxyethylene addition mol number: 2 to 100), polypropylene glycol monomethacrylate (polyoxypropylene addition mol number: 2 to 100), 2-carboxyethylmethacrylate, 3-sulfopropylmethacrylate, 4-oxysulfobutylmethacrylate, 3-trimethoxysilylpropylmethacrylate and allylmethacrylate), derivatives of unsaturated dicarboxylic acids (e.g., monobutyl maleate, dimethyl maleate, monomethyl itaconate and dibutyl itaconate) and polyfunctional esters (e.g., ethylene glycol diacrylate, ethylene glycol dimethacrylate, 1,4-cyclohexanediacrylate, pentaerythritol tetramethacrylate, pentaerythritol triacrylate, trimethylolpropanetriacrylate, trimethylolethanetriacrylate, dipentaerythritol pentamethacrylate, pentaerythritol hexaacrylate and 1,2,4-cyclohexanetetramethacrylate).

Examples of the α,β-unsaturated carboxylic acid amides include acrylamide, methacrylamide, N-methylacrylamide, N,N-dimethylacrylamide, N-methyl-N-hydroxyethylacrylamide, N-tert-butylacrylamide, N-tert-octylmethacrylamide, N-cyclohexylacrylamide, N-phenylacrylamide, N-(2-acetoacetoxyethyl)acrylamide, N-acryloylmorpholine, diacetonacrylamide, itaconic acid diamide, N-methylmaleimide, 2-acrylamido-2-methylpropanesulfonic acid, methylenebisacrylamide and dimethacryloylpiperazine.

Examples of the styrene and its derivatives include styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, 1,4-divinylbenzene, 4-vinylbenzoic acid-2-acryloylethyl ester.

Examples of the vinyl ethers include methyl vinyl ether, butyl vinyl ether and methoxyethyl vinyl ether.

Examples of the above vinylesters include vinyl acetate, vinyl propionate, vinyl benzoate, vinyl salicylate and vinyl chloroacetate.

Examples of other polymerizable monomers include N-vinylpyrrolidone, 2-vinyloxazoline, 2-isopropenyloxazoline and divinylsulfone.

Among the hydrophobic polymers according to the invention which polymers are synthesized by copolymerization of a combination of the above monomers, those consisting of, as a major component, a homopolymer or copolymer of an acrylamide, methacrylamide, acrylate, methacrylate, styrene, vinylester, vinyl ether or olefin are preferably selected.

As the hydrophobic polymer contained in the color fine particle dispersion and ink composition of the invention, a hydrophobic polymer having an equilibrium moisture content of 3% or less at 25° C. under a relative humidity of 60% RH is preferable. When the above equilibrium moisture content of the hydrophobic polymer is less than 3%, this is preferable because the ink composition containing the color fine particle dispersion including the hydrophobic polymer is less affected by the magnitude of the environmental humidity so that the humidity dependency of the physical properties and durability of the ink composition are improved. When the equilibrium moisture content exceeds 3%, there is the case where the effect of the humidity is increased to the extent that it cannot be neglected. The above equilibrium moisture content of the hydrophobic polymer of the invention is more preferably 2% by mass or less and most preferably 1.5% by mass or less.

In this specification, the above term “the equilibrium moisture content (mass%) at 25° C. under a relative humidity of 60% RH” may be calculated according to the following equation from the weight W₁of a polymer which weight is found in a humidity equilibrium condition under an environment of 25° C. and a relative humidity of 60% RH and from the weight of the polymer which weight is found at the same temperature in an absolute dry condition.

Equilibrium moisture content (25° C. and 60% RH)={(W₁−W₀)/W₀}×100

There may be references to the definition and measuring method of the equilibrium moisture content in, for example, “Polymer Engineering Course 14, Polymer Material Test Method” (edited by The Society of Polymer Science, Japan, CHIJIN SHOKAN CO., LTD.).

The hydrophobic polymer contained in the color fine dispersion and ink composition of the invention has a glass transition temperature (Tg) of 40° C. or more to eliminate clogging of a nozzle and to better and improve ink-discharging characteristics in the ink jet recording. As regards the glass transition temperature (Tg), hydrophobic polymers having a glass transition temperature of 45° C. or more are more preferable and hydrophobic polymers having a Tg of 50° C. or more are most preferable. Although no particular limitation to the upper limit of the glass transition temperature (Tg), the glass transition temperature is sufficiently about 180° C. in the case of usual ink jet recording ink.

In this specification, the glass transition temperature (Tg) in the case of a copolymer is calculated according to the following equation.

1/Tg=Σ(xᵢ/Tgᵢ)

In the above formula, it is supposed that a copolymerized polymer is obtained by copolymerizing n (i=1 to n) monomer units. Xᵢ is the mass fraction (Σxᵢ=1) of the (i)th monomer, Tgᵢ is the glass transition temperature (absolute temperature indication) of the (i)th monomer and Σtakes the sum (i=1 to n). As the value of the glass transition temperature (Tgᵢ) of a homopolymer of each monomer, for example, the values described in J. Brandrup, E. H. Immergut, “Polymer Handbook” (3rd Edition, Wiley-Interscience, (1989)) may be adopted.

Two or more hydrophobic polymers may be used together as the hydrophobic polymer used in the invention. When two or more polymers differing in glass transition temperature are blended upon use, it is necessary that the mass average Tg falls in the above temperature range, namely 40° C. or more.

As the hydrophobic polymer in the invention, hydrophilic polymers dispersible in an aqueous solvent are preferable. As regards examples of dispersion states, any of a latex in which fine particles of a water-insoluble polymer are dispersed, dispersions in which a polymer molecule is dispersed in a molecular state or forming a micell and the like may be adopted. However, particles which are dispersed as a latex are preferable. The average particle diameter of the dispersed particles is in a range from 1 to 50000 nm, preferably 5 to 1000 nm, more preferably 10 to 500 nm and particularly preferably 50 to 200 nm. No particular limitation is imposed on the particle diameter distribution of the dispersed particles and the dispersed particles may have wide particle diameter distribution or monodispersible particle diameter distribution. Also, it is a preferable method of use for controlling the qualities of an ink composition solution that two types of particles each having monodispersible particle distribution are blended upon use.

As regards preferable and specific examples of the hydrophobic polymer dispersible in an aqueous medium, hydrophobic polymers such as acryl type polymers, polyesters, rubbers (e.g., SBR rubber), polyurethanes, polyvinyl chlorides, polyvinyl acetates, polyvinylidene chlorides and polyolefins may be preferably used. These polymers may be straight-chain, branched-chain or crosslinked polymers, or so-called homopolymers obtained by polymerizing a single polymer or copolymers obtained by copolymerizing two or more types of monomers. Also, in the case of copolymers, these copolymers may be random copolymers, block copolymers or graft copolymers. As to the molecular weight of each of these copolymers, the number average molecular weight is preferably 5000 to 1000000 and polymers having a number average molecular weight of 10000 to 200000 are more preferable. In the case of polymers having an average molecular weight excessively smaller than the above range, there is the case where the mechanical strength of the emulsion layer is insufficient, whereas in the case polymers having a molecular weight excessively larger than the above range, there is the case where film-forming properties are deteriorated, and the above both cases are undesirable. Also, a crosslinkable polymer latex is used particularly preferably.

The aqueous solvent in which the hydrophobic polymer is soluble or dispersible means water or mixed solvents prepared by mixing 70% by mass or less of a water-miscible organic solvent in water. Examples of the water-miscible solvent include alcohol types such as methyl alcohol, ethyl alcohol and propyl alcohol, cellosolve types such as methyl cellosolve, ethyl cellosolve and butyl cellosolve, ethyl acetate and dimethylformamide.

In also the case of a system in which the hydrophobic polymer is not dissolved thermodynamically completely but exists in a so-called dispersed state, the term “aqueous solvent” is used in this specification.

Specific examples of the hydrophobic polymer used in the invention and the glass transition temperatures (Tg) of these examples will be explained hereinbelow: however, these examples are not intended to be limiting of the invention.

| | | |
|---|---|---|
| (P-1) | Poly(4-biphenylacrylate) | Tg = 110° C. |
| (P-2) | Poly(t-butylacrylate) | Tg = 107° C. |
| (P-3) | Poly(2-chloroacrylate) | Tg = 53° C. |
| (P-4) | Poly(2-naphthylacrylate) | Tg = 85° C. |
| (P-5) | Poly(acrylamide) | Tg = 165° C. |
| (P-6) | Poly(N-butylacrylamide) | Tg = 46° C. |
| (P-7) | Poly(N-t-butylacrylamide) | Tg = 128° C. |
| (P-8) | Poly(benzylmethacrylate) | Tg = 54° C. |
| (P-9) | Poly(t-butylmethacrylate) | Tg = 118° C. |
| (P-10) | Poly(4-t-butylcyclohexylmethacrylate) | Tg = 83° C. |
| (P-11) | Poly(ethylmethacrylate) | Tg = 65° C. |
| (P-12) | Poly(iso-propylmethacrylate) | Tg = 81° C. |
| (P-13) | Poly(methylmethacrylate) | Tg = 105° C. |
| (P-14) | Poly(phenylmethacrylate) | Tg = 110° C. |
| (P-15) | Poly(styrene) | Tg = 100° C. |
| (P-16) | Poly(2-ethylstyrene) | Tg = 103° C. |
| (P-17) | Poly(2-ethoxymethylstyrene) | Tg = 74° C. |
| (P-18) | Poly[4-(1-hydroxy-1-methylbutyl)styrene] | Tg = 130° C. |
| (P-19) | Poly(2-methylstyrene) | Tg = 136° C. |
| (P-20) | Poly(4-propoxystyrene) | Tg = 70° C. |
| (P-21) | Poly(4-acetylstyrene) | Tg = 116° C. |

And copolymers comprising desired combinations of the structural units (monomers) of the above polymers are exemplified.

The above hydrophobic polymers may be used either singly or, as required, in combinations of two or more.

The amount of the hydrophobic polymer used for the preparation of the color fine particle of the invention is preferably 10 to 500% by mass and more preferably 20 to 300% by mass based on the dyes coexisting in the color fine particle. High-boiling point organic solvent

Next, the high-boiling point organic solvent used in the invention will be explained.

The color fine particle dispersion of the invention can be prepared by mixing a solution containing at least an oil-soluble dye, a hydrophobic polymer and a high-boiling point organic solvent and, according to the need, an auxiliary solvent which has a boiling point of 200° C. or less and a solubility of 25 g or less in water with an aqueous medium and by emulsion-dispersing the mixture, followed by removing the auxiliary solvent when the auxiliary solvent is used.

In the preparation of the color fine particle dispersion, the high-boiling point organic solvent is an essential component to form a color fine particle which is superior in hue and is stable.

In the invention, the high-boiling point organic solvent means an organic solvent having a boiling point of 200° C. or more and a melting point of 80° C. or less and is particularly preferably an organic solvent in which the solubility of water is 4 g or less at 25° C. When the solubility (25° C.) of water exceeds 4 g, enlargement of particle diameters and aggregation of particles tend to be caused and there is therefore the case where ink-discharging characteristics are adversely affected seriously. The solubility of water is preferably 4 g or less, more preferably 3 g or less, particularly preferably 2 g or less, and most preferably 1 g or less.

In this specification, the term “solubility of water” means the saturated concentration of water in the high-boiling point organic solvent at 25° C. and specifically the weight (g) of water which can be dissolved in 100 g of the high-boiling point solvent at 25° C.

The amount of the high-boiling point solvent to be used according to the invention is preferably 5 to 200% by mass and more preferably 10 to 100% by mass based on the coexistent dye of the color fine particle.

In the invention, compounds represented by the following formulate [S-1] to [S-9 are preferable as the high-boiling point solvent.

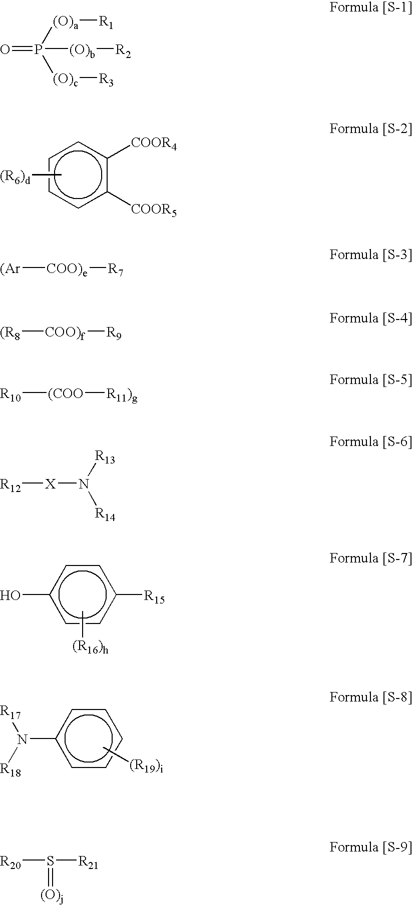

In the formula [S-1], R₁, R₂ and R₃ each independently represents an aliphatic group or an aryl group. Also, a, b and c each independently denotes 0 or 1.

In the formula [S-2], R₄ and R₅ each independently represents an aliphatic group or an aryl group, R₆ represents a halogen atom (F, Cl, Br or I, the same as follows), an alkyl group, an alkoxy group, an aryloxy group, an alkoxycarbonyl group or an aryloxycarbonyl group and d denotes an integer from 0 to 3. When d is the plural number, plural R₆s may be the same or different.

In the formula [S-3], Ar represents an aryl group, e denotes an integer from 1 to 6 and R₇ represents a hydrocarbon group having e valences or a hydrocarbon group having an ether bond.

In the formula [S-4], R₈ represents an aliphatic group, f denotes an integer from 1 to 6 and R₉ represents a hydrocarbon group having f valences or a hydrocarbon group having an ether bond.

In the formula [S-5], g denotes an integer from 2 to 6, R₁₀ represents a hydrocarbon group (provided that an aryl group is excluded) having g valences and R₁₁ represents an aliphatic group or an aryl group.

In the formula [S-6], R₁₂, R₁₃ and R₁₄ each independently represents a hydrogen atom, an aliphatic group or an aryl group. X represents —CO— or —SO₂—, R₁₂ and R₁₃ or R₁₃ and R₁₄ may be combined with each other to form a ring.

In the formula [S-7], R₁₅ represents an aliphatic group, an alkoxycarbonyl group, an aryloxycarbonyl group, an alkylsulfonyl group, an arylsulfonyl group, an aryl group or a cyano group, R₁₆ represents a halogen atom, an aliphatic group, an aryl group, an alkoxy group or an aryloxy group and h denotes an integer from 0 to 3. When h is the plural number, plural R₁₆s may be the same or different.

In the formula [S-8], R₁₇ and R₁₈ each independently represents an aliphatic group or an aryl group, R₁₉ represents a halogen atom, an aliphatic group, an aryl group, an alkoxy group or an aryloxy group and i denotes an integer from 0 to 4. When i is the plural number, plural R₁₉s may be the same or different.

In the formula [S-9], R₂₀ and R₂₁ represent an aliphatic group or an aryl group. j denotes 1 or 2.

In the formula [S-1] to [S-9], when R₁ to R₆, R₈ and R₁₁ to R₂₁ are respectively an aliphatic group or a group having an aliphatic group, the aliphatic group may be any of straight-chain, branched-chain and cyclic groups and may also have an unsaturated bond and a substituent. Examples of the substituent include a halogen atom, aryl group, alkoxy group, aryloxy group, alkoxycarbonyl group, hydroxyl group, acyloxy group and epoxy group.

In the formulate [S-1] to [S-9], when R₁ to R₆, R₈ and R₁₁ to R₂₁ are respectively a cyclic aliphatic group, namely, a cycloalkyl group or a group having a cycloalkyl group, the cycloalkyl group may have an unsaturated bond in a three- to eight-membered ring, and may also contain a substituent and a crosslinking group. Examples of the substituent include a halogen atom, aliphatic group, hydroxyl group, acyl group, aryl group, alkoxy group, epoxy group and alkyl group. Examples of the crosslinking group include methylene, ethylene and isopropylidene.

In the formulae [S-1] to [S-9], when R₁ to R⁶, R₈ and R₁₁ to R₂₁ are respectively an aryl group or a group having an aryl group, the aryl group may be substituted with a substituent such as a halogen atom, aliphatic group, aryl group, alkoxy group, aryloxy group or alkoxycarbonyl group.

In the formulate [S-3], [S-4] and [S-5], when R₇, R₉ or R₁₀ is a hydrocarbon group, the hydrocarbon group may contain a cyclic structure (e.g., a benzene ring, cyclopentane ring or a cyclohexane ring) and an unsaturated bond and may also have a substituent. Examples of the substituent include a halogen atom, hydroxyl group, acyloxy group, aryl group, alkoxy group, aryloxy group and epoxy group.

Among the high-boiling point organic solvents represented by the formulate [S-1] to [S-9], particularly preferable high-boiling point organic solvents will be mentioned.

In the formula [S-1], R₁, R₂ and R₃ each independently represents an aliphatic group having 1 to 24 (preferably 4 to 18) carbon atoms (hereinafter abbreviated as C-number) (e.g., n-butyl, 2-ethylhexyl, 3,3,5-trimethylhexyl, n-dodecyl, n-octadecyl, benzyl, oleyl, 2-chloroethyl, 2,3-dichloropropyl, 2-butoxyethyl, 2-phenoxyethyl, cyclopentyl, cyclohexyl, 4-t-butylcyclohexyl and 4-methylcyclohexyl) or an aryl group having a C-number of 6 to 24 (preferably 6 to 18) (e.g., phenyl, cresyl, p-nonylphenyl, xylyl, cumenyl, p-methoxyphenyl and p-methoxycarbonylphenyl). a, b and c respectively denotes 0 or 1. All of a, b and c are more preferably 1.

In the formula [S-2], R₄ and R₅ each independently represents an aliphatic group having a C-number of 1 to 24 (preferably 4 to 18) (e.g., the same groups as the alkyl groups exemplified as the above R₁, ethoxycarbonylmethyl, 1,1-diethylpropyl, 2-ethyl-l-methylhexyl, cyclohexylmethyl, 1-ethyl-1,5-dimethylhexyl, 3,5,5-trimethylcyclohexyl, menthyl, bornyl and 1-methylcyclohexyl) or an aryl group having a C-number of 6 to 24 (preferably 6 to 18) (e.g., the aryl groups exemplified as the above R₁, 4-t-butylphenyl, 4-t-octylphenyl, 1,3,5-trimethylphenyl, 2,4-di-t-butylphenyl and 2,4-di-t-pentylphenyl), R₆ represents a halogen atom (preferably a chlorine atom), an alkyl group having a C-number of 1 to 18 (e.g., methyl, isopropyl, t-butyl and n-dodecyl), an alkoxy group having a C-number of 1 to 18 (e.g., methoxy, n-butoxy, n-octyloxy, methoxyethoxy and benzyloxy), an aryloxy group having a C-number of 6 to 18 (e.g., phenoxy, p-tolyloxy, 4-methoxyphenoxy and 4-t-butylphenoxy) or an alkoxycarbonyl group having a C-number of 2 to 19 (e.g., methoxycarbonyl, n-butoxycarbonyl and 2-ethylhexylcarbonyl) or an aryloxycarbonyl group having a C-number of 6 to 25 and d denotes 0 or 1.

In the formula [S-3], Ar represents an aryl group having a C-number of 6 to 24 (preferably 6 to 18) (e.g., phenyl, 4-chlorophenyl, 4-methoxyphenyl, 1-naphthyl, 4-n-butoxyphenyl and 3,5-trimethylphenyl), e denotes an integer from 1 to 4 (preferably 1 to 3) and R₇ represents a hydrocarbon group having e valences and a C-number of 2 to 24 (preferably 2 to 18) (e.g., the alkyl groups, cycloalkyl groups, aryl groups and —(CH₂)₂—,

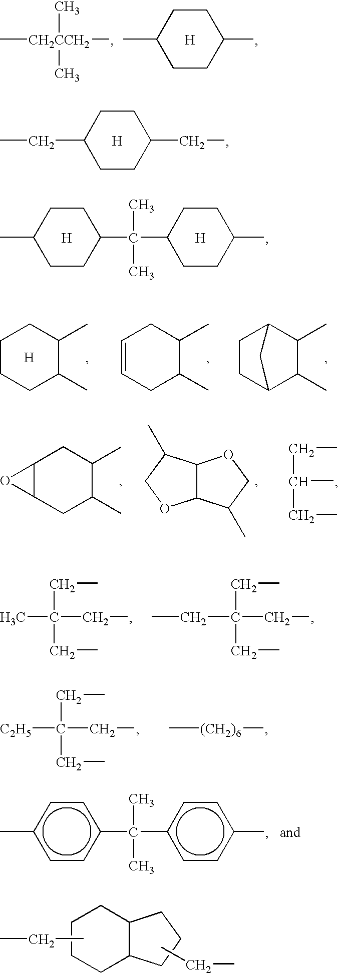

exemplified as the above R₄)

or a hydrocarbon group having e valences, 4 to 24 (preferably 4 to 18) carbon atoms and an ether bond (e.g., —CH₂CH₂OCH₂CH₂—, —CH₂CH₂(OCH₂CH₂)₃—, —CH₂CH₂CH₂OCH₂CH₂CH₂—,

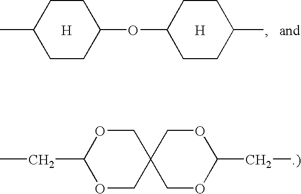

In the formula [S-4], R₈ represents an aliphatic group having a C-number of 1 to 24 (preferably 1 to 17) (e.g., methyl, n-propyl, 1-hydroxyethyl, 1-ethylpentyl, n-undecyl, pentadecyl, 8,9-epoxyheptadecyl, cyclopropyl, cyclohexyl and 4-methylcyclohexyl), f denotes an integer from 1 to 4 (preferably 1 to 3), R₉ represents a hydrocarbon group having f valences and a C-number of 2 to 24 (preferably 2 to 18) or a hydrocarbon group having c valences, 4 to 24 (preferably 4 to 18) carbon atoms and an ether bond (e.g., the groups exemplified as the above R₇).

In the formula [S-5], g denotes a number of 2 to 4 (preferably 2 or 3), R₁₀ represents a hydrocarbon group having g valences (e.g., —CH₂—, (CH₂)₂—, —(CH₂)₄—, —(CH₂)₇—,

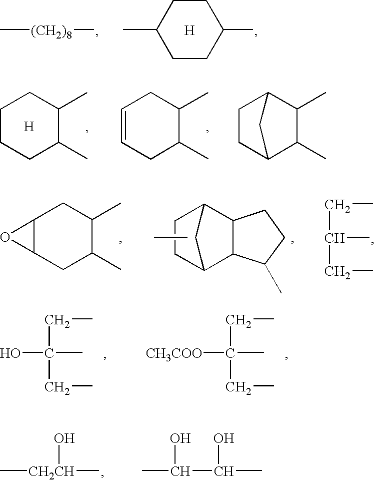

R₁₁ represents an aliphatic group having a C-number of 1 to 24 (preferably 4 to 18) or an aryl group having a C-number of 6 to 24 (preferably 6 to 18) (e.g., the aliphatic groups and aryl groups exemplified as the above R₄)

In the formula [S-6], R₁₂ represents a hydrogen atom, an aliphatic group having a C-number of 1 to 24 (preferably 3 to 20) (e.g., n-propyl, 1-ethylpentyl, n-undecyl, n-pentadecyl, 2,4-di-t-pentylphenoxymethyl, 4-t-octylphenoxymethyl, 3-(2,4-di-t-butylphenoxy)propyl, 1-(2,4-di-t-butylphenoxy)propyl, cyclohexyl and 4-methylcyclohexyl) or an aryl group having a C-number of 6 to 24 (preferably 6 to 18) (e.g., the aryl groups exemplified as the above Ar), R₁₃ and R₁₄ each independently represents a hydrogen atom, an aliphatic group having a C number of 1 to 24 (preferably 1 to 18) (e.g., methyl, ethyl, isopropyl, n-butyl, n-hexyl, 2-ethylhexyl, n-dodecyl, cyclopentyl and cyclopropyl) or an aryl group having a C-number of 6 to 18 (preferably 6 to 15) (e.g., phenyl, 1-naphthyl and p-tolyl). R₁₃ and R₁₄ may be combined with each other to form a pyrrolidine ring, piperidine ring or morpholine ring in combination with N. R₁₂ and R₁₃ may be combined with each other to form a pyrrolidone ring. X represents —CO— or —SO₂— and preferably —CO—.

In the formula [S-7], R₁₅ represents an aliphatic group having a C-number of 1 to 24 (preferably 3 to 18) (e.g., methyl, isopropyl, t-butyl, t-pentyl, t-hexyl, t-octyl, 2-butyl, 2-hexyl, 2-octyl, 2-dodecyl, 2-hexadecyl, t-pentadecyl, cyclopentyl and cyclohexyl), an alkoxycarbonyl group having a C-number of 2 to 24 (preferably 5 to 17) (e.g., n-butoxycarbonyl, 2-ethylhexyloxycarbonyl and n-dodecyloxycarbonyl), an alkylsulfonyl group having a C-number of 1 to 24 (preferably 1 to 18) (e.g., methylsulfonyl, n-butylsulfonyl and n-dodecylsulfonyl), an arylsulfonyl group having a C-number of 6 to 30 (preferably 6 to 24) (e.g., p-tolylsulfonyl, p-dodecylphenylsulfonyl and p-hexadecyloxyphenylsulfonyl), an aryl group having a C-number of 6 to 32 (preferably 6 to 24) (e.g., phenyl and p-tolyl) or a cyano group, R₁₆ represents a halogen atom (preferably Cl), an alkyl group having a C-number of 1 to 24 (preferably 1 to 18) (e.g., the alkyl groups exemplified as the above R₁₅), a cycloalkyl group having a C-number of 3 to 18 (preferably 5 to 17) (e.g., cyclopentyl and cyclohexyl), an aryl group having a C-number of 6 to 32 (preferably 6 to 24) (e.g., phenyl and p-tolyl), an alkoxy group having a C-number of 1 to24 (preferably 1 to 18) (e.g., methoxy, n-butoxy, 2-ethylhexyloxy, benzyloxy, n-dodecyloxy and n-hexadecyloxy) or an aryloxy group having a C-number of 6 to 32 (preferably 6 to 24) (e.g., phenoxy, p-t-butylphenoxy, p-t-octylphenoxy, m-pentadecylphenoxy and p-dodecyloxyphenoxy) and h denotes an integer of 1 or 2.

In the formula [S-8], R₁₇ and R₁₈ are the same as the above R₁₃ and R₁₄ respectively and R₁₉ is the same as the above R¹⁶.

In the formula [S-9], R₂₀ and R₂₁ are the same as the above R₂ and R₃ respectively and j denotes 1 or 2 and preferably 1.

Specific examples of the high-boiling point organic solvent used in the invention preferably include the compounds (S-1 to S-93) described in Japanese Patent Application No. 2002-10361: however, these compounds are not intended to be limiting of the invention.

In the invention, these high-boiling point organic solvents may be used either singly or by mixing two or more (e.g., tricresyl phosphate and dibutyl phthalate, trioctyl phosphate and di(2-ethylhexyl) sebacate or dibutyl phthalate and poly(N-t-butylacrylamide).

In the invention, the ratio by mass of the oil-soluble dye to the high-boiling point organic solvent (oil-soluble dye:high-boiling point organic solvent) is preferably 1:0.01 to 1:1 and more preferably 1:0.05 to 1:0.5.

Examples of compounds other than the above compounds as the high-boiling point organic solvent used in the invention and/or methods of synthesizing these high-boiling point solvents are described in each specification of U.S. Pat. Nos. 2,322,027, 2,533,514, 2,772,163, 2,835,579, 3,594,171, 3,676,137, 3,689,271, 3,700,454, 3,748,141, 3,764,336, 3,765,897, 3,912,515, 3,936,303, 4,004,928, 4,080,209, 4,127,413, 4,193,802, 4,207,393, 4,220,711, 4,239,851, 4,278, 757, 4,353,979, 4,363,873, 4,430,421, 4,430,422, 4,464,464, 4,483,918, 4,540,657, 4,684,606, 4,728,599, 4,745,049, 4,935,321 and 5,013,639, E.P. Nos. 276,319A, 286,253A, 289,820A, 309,158A, 309,159A, 309,160A, 509,311A and 510,576A, D.D. Patent Nos. 147,009, 157,147, 159,573 and 225,240A and U.K. Patent Nos. 2,091,124A and JP-A Nos. 48-47335, 50-26530, 51-25133, 51-26036, 51-27921, 51-27922, 51-149028, 52-46816, 53-1520, 53-1521, 53-15127, 53-146622, 54-91325, 54-106228, 54-118246, 55-59464, 56-64333, 56-81836, 59-204041, 61-84641, 62-118345,62-247364, 63-167357,63-214744, 63-301941,64-9452, 64-9454, 64-68745, 1-101543, 1-102454, 2-792, 2-4239, 2-43541, 4-29237, 4-30165, 4-232946 and 4-346338.

Auxiliary Solvent

In the invention, an auxiliary solvent may be used according to the need together with the aforementioned high-boiling point organic solvent. This auxiliary solvent is a low-boiling point solvent or a water-soluble organic solvent, which is to be removed by means of vaporization, membrane dialysis, ultrafiltration or the like after the emulsion dispersion of an organic solvent phase containing a dye.

In the case of preparing the color fine particle comprising at least the oil-soluble dye, the hydrophobic polymer and the high-boiling point organic solvent according to the invention, the solubility of the auxiliary solvent in water is preferably smaller in order to obtain a dispersion which has a narrow distribution of particle size and which is also stable. On the other hand, the auxiliary solvent must be dissolved in water to some extent in order to remove it smoothly and easily after the emulsion dispersion. Therefore, solvents which are perfectly dissolved in water, for example, methanol, ethanol, isopropyl alcohol, acetone and the like are undesirable in the viewpoint of obtaining a dispersion which has a narrow distribution of particle size and which is also stable.

In the invention, the solubility (25° C., based on 100 g of water) of the auxiliary solvent in water is preferably 0.5 or more and 25 g or less and more preferably 1 g or more and 20 g or less.

Specific examples (AS-1 to 11) of the auxiliary solvent and the solubility of each in water are shown below: however, these examples are not intended to be limiting of the invention.

| | | |
|---|---|---|
| (AS-1) | Ethyl acetate | 8 g |
| (AS-2) | Propyl acetate | 2 g |
| (AS-3) | 2-Ethylbutyl acetate | <1 g |
| (AS-4) | 2-Ethylene acetate | 20 g |
| (AS-5) | 2-Ethoxyethyl acetate | 25 g |
| (AS-6) | Butyl acetate | 2 g |
| (AS-7) | Ethyl propionate | 2 g |
| (AS-8) | Acetylacetone | 12 g |
| (AS-9) | Ethyl acetoacetate | 12 g |
| (AS-10) | 2-(2-n-butoxyethoxy)ethyl acetate | 2 g |
| (AS-11) | Cyclohexanone | 15 g |

In the invention, the amount of the auxiliary solvent is preferably 1 to 200 times the weight and more preferably 2 to 100 times the weight to the dye coexisting in the color fine particle.

Preparation of the Color Fine Particle and the Ink Composition

The color fine particle according to the invention may be prepared, for example, in the following manner. Specifically, a solution (hereinafter called “oil phase” as the case may be) containing at least one of the above hydrophobic dyes, at least one of the above hydrophobic polymers whose glass transition temperature (Tg) is 40° C. or more, at least one of the aforementioned high-boiling point organic solvents (solubility in water is 4 g or less) and at least one of the above auxiliary solvents (boiling point is 200° C. or less and solubility in water is 25 g or less) is mixed with an aqueous medium (hereinafter called “water phase” as the case may be) to emulsify and disperse, followed by removing the above auxiliary solvent, whereby the color fine dispersion can be obtained. Also, the ink composition of the invention comprises the color fine particle.

In the above emulsion dispersion, additives such as a surfactant, a humectant, a dye stabilizer, an emulsion stabilizer, an antiseptic and a mildew-proofing agent which are explained later may be added either one or both of the water phase and oil phase according to the need.

Preferable examples of the surfactant include anionic surfactants such as a fatty acid salts, alkyl sulfate, alkylbenzene sulfonate, alkylnaphthalene sulfonate, dialkyl sulfosuccinate, alkyl phosphate, naphthalenesulfonic acid formalin condensate and polyoxyethylenealkyl sulfate, nonionic surfactants such as a polyoxyethylene alkyl ether, polyoxyethylene alkylallyl ether, polyoxyethylene fatty acid ester, sorbitan fatty acid ester, polyoxyethylenesorbitan fatty acid ester, polyoxyethylenealkylamine, glycerol fatty acid ester and oxyethylene oxypropylene block copolymer, “SURFYNOLS” (trade name, manufactured by Air Products and Chemicals, Inc.) which is an acetylene type polyoxyethylene oxide surfactant, amine oxide type amphoteric surfactants such as N,N-dimethyl-N-alkylamine oxide and those described in the JP-A No. 59-157,636, pp.37-38 and Research Disclosure No. 308119 (1989).

In the invention, a water-soluble polymer may be added together with these surfactants with the intention of improving stability just after emulsification is finished.

Preferable examples of the water-soluble polymer include a polyvinyl alcohol, polyvinylpyrrolidone, polyethylene oxide, polyacrylic acid and polyacrylamide, copolymers of these compounds, and natural water-soluble polymers such as polysaccharides, casein and gelatin.

When preparing a color fine particle by the emulsion dispersion and an ink composition containing the color fine particle, it is particularly important to control the size of the color fine particle from the viewpoint of improving printing characteristics.

The average particle diameter of the color fine particle of the invention can be measured with ease using a known method. For example, an ink composition is diluted with distilled water such that the concentration of a dye in the ink composition becomes 0.1 to 1% by mass and then, the average particle diameter can be simply measured using a commercially available volume average particle diameter measuring instrument. Preferable examples of the measuring instrument include “Microtrac UPA” (trade name, manufactured by Nikkiso Co., Ltd.).

As to the size of the color fine particle contained in the ink composition of the invention, the average particle diameter is preferably 0.01 to 0.5 μm, more preferably 0.01 to 0.3 μm and particularly preferably 0.01 to 0.2 μm from the viewpoint of obtaining high printing characteristics and the large effect (improvement in jetting characteristics) of the invention.

The specific gravity of the color fine particle of the invention is preferably 0.90 to 1.20, more preferably 0.93 to 1.10 and particularly preferably 0.95 to 1.05. If the specific gravity is out of the above range, it is difficult for the color fine particle to exist stably in a water phase system.

The specific gravity of the color fine particle may be measured as follows: a solution consisting of the structural components of the color fine particle is prepared and then a solid obtained by removing an auxiliary solvent from the solution is measured using or applying, for example, the method described in “New Experimental Chemistry Course”, vol. 1 (MARUZEN CO., LTD.), pp.79-82.

In the ink composition of the invention, the presence of coarse particles seriously affects printing characteristics. Specifically, it has been found that coarse particles clog a head nozzle or even if they do not clog the nozzle, they cause contamination, thereby preventing the ink composition from jetting and causing jetting slippage, which affects printing characteristics seriously.

To prevent this, it is preferable to limit particles having a size of 5 μm or more to 10 or less in number in 1 μL ink and particles having a size of 1 μm or more to 1000 or less in number in 1 μL ink when the ink composition of the invention is used for ink jet recording.

As a method of removing these coarse particles, a known centrifugation method, fine filtration method or the like may be used. These separating means may be used just after emulsion dispersion or just before the ink composition is filled in an ink cartridge after adding various additives such as a humectant and surfactants to the emulsion dispersion.

As means effective to decrease the average particle diameter of the color fine particle and to lessen coarse particles, an emulsifying and dispersing apparatus with mechanical stirring may be preferably used.

As the emulsifying and dispersing apparatus, known apparatuses such as simple stirrer or impeller stirring systems, inline stirring systems, milling systems such as a colloid mill and ultrasonic systems may be used. In the invention, high pressure emulsifying and dispersing apparatuses are preferable. Among these apparatuses, a high pressure homogenizer is preferable.

As regards the above high pressure homogenizer, its detailed mechanism is described in, for example, the specification of U.S. Pat. No. 4,533,254 and the JP-A No. 6-47264. Examples of commercially available apparatuses include “Gaulin homogeniser” (trade name, manufactured by A. P. V GAULIN INC.), “Microfluidizer” (trade name, manufactured by MFIC Corporation) and “Ultimaizer” (trade name, manufactured by SUGINO MACHINE LIMITED).

Also, a high pressure homogenizer provided with a mechanism which works to micronize particles in an extra-high pressure jet stream as described in the specification of U.S. Pat. No. 5,720,551 which has been recently reported is particularly effective for emulsifying and dispersing the color fine particle of the invention. Examples of emulsifying and dispersing apparatuses using this extra-high pressure jet stream include “DeBEE 2000” (trade name, manufactured by B.E.E. INTERNATIONAL LTD.).

The pressure when carrying out emulsification and dispersion by using the high pressure emulsifying and dispersing apparatus is preferably 50 MPa or more (500 bar or more), more preferably 60 MPa or more (600 bar or more) and still more preferably 180 MPa or more (1800 bar or more).

In the invention, two or more types of emulsifiers are particularly preferably used in a method in which after emulsification using a stirring emulsifier is finished, the emulsion is passed through a high pressure homogenizer, when carrying out emulsification and dispersion. Also, a method is preferable in which emulsification and dispersion is carried out in these emulsifiers once and then additives such as a humectant and surfactants are added to the emulsified dispersion, which is then passed again through a high pressure homogenizer in a step of filling a cartridge with the ink composition.

In the case of using the auxiliary solvent in addition to the high-boiling point organic solvent when carrying out the above emulsification and dispersion, it is preferable to remove the auxiliary solvent substantially from the viewpoint of the stability of the resulting emulsion (color fine particle) and environmental sanitation.

As a method of substantially removing the auxiliary solvent, various known methods, for example, a vaporizing method, vacuum vaporization method, ultrafiltration method or the like may be adopted corresponding to the type of auxiliary solvent. The step of removing the auxiliary solvent is preferably carried out as rapidly as possible just after the emulsification.

The ink composition of the invention may be used in various fields and is preferably used as ink compositions for writing aqueous inks, aqueous printing inks and information recording inks.

The ink composition of the invention may contain other components which are appropriately selected according the need in addition to the aforementioned components.

Examples of the above other components include known additives such as an anti-dryness agent, penetration promoter, ultraviolet absorber, antioxidant, mildewproof agent, pH regulator, surface tension regulator, antifoaming agent, viscosity regulator, dispersant, dispersion stabilizer, rust preventives and chelating agent.

The anti-dryness agent is preferably used for the purpose of preventing clogging caused by dried ink at the ink-discharging port of a nozzle used for an ink jet recording method.

As the anti-dryness agent, water-soluble organic solvents having a lower vapor pressure than water are preferable. Specific examples of the anti-dryness agent include polyhydric alcohols represented by ethylene glycol, propylene glycol, diethylene glycol, polyethylene glycol, thiodiglycol, dithioglycol, 2-methyl-1,3-propanediol, 1,2,3-hexatriol, acetylene glycol derivatives, glycerol and trimethylolpropane, lower alkyl ethers of polyhydric alcohols such as ethylene glycol monomethyl (or ethyl) ether or triethylene glycol monoethyl (or butyl) ether, hetero rings such as 2-pyrrolidone, N-methyl-2-pyrrolidone, 1,3-dimethyl-2-imidazolidinone and N-ethylmorpholine, sulfur-containing compounds such as sulfolane, dimethylsulfoxide and 3-sulfolane, polyfunctional compounds such as diacetone alcohol and diethanolamine and urea derivatives. Among these compounds, polyhydric alcohols such as glycerol diethylene glycol are particularly preferable.

These anti-dryness agents may be either singly or in combinations of two or more. These anti-dryness agents are preferably contained in an amount of 10 to 50 mass parts in the ink composition.

Examples of the penetration promoter include alcohols such as ethanol, isopropanol, butanol, diethylene glycol monobutyl ether, triethylene glycol monobutyl ether and 1,2-hexanediol, sodium laurylsulfate, sodium oleate and the nonionic surfactants exemplified as the above surfactants for emulsification and dispersion. If these penetration promoters are added in an amount of 10 to 30% by mass, a sufficient effect is obtained and therefore, these penetration promoters are added to the extent that spreading of prints is not caused and a print-through phenomenon does not occur.

The ultraviolet absorber is used for the purpose of improving the preserving characteristics of an image. Examples of the ultraviolet absorber include benzotriazole type compounds described in JP-A Nos. 58-185677, 61-190537, 2-782, 5-197075, 9-34057 and the like, benzophenone type compounds described in JP-A Nos. 46-2784 and 5-194483 and the specification of U.S. Pat. No. 3,214,463, cinnamic acid type compounds described in JP-B Nos. 48-30492 and 56-21141 and the JP-A No. 10-88106, triazine type compounds described in JP-A Nos. 4-298503, 8-53427, 8-239368 and 10-182621 and Japanese Patent Application National Publication (Laid-Open) No. 8-501291 and also so-called fluorescent brighteners, which are compounds absorbing ultraviolet rays to emit fluorescent light and represented by the compounds described in Research Disclosure No. 24239 and stilbene type or benzoxazole type compounds.

The antioxidant is used for the purpose of improving the preserving characteristics of an image and preferable examples of the antioxidant include various organic type or metal complex type anti-fading agents.

Examples of the organic anti-fading agent include hydroquinones, alkoxyphenols, dialkoxyphenols, phenols, anilines, amines, indanes, chromans, alkoxyanilines and hetero rings.

Examples of the metal complex type anti-fading agent include nickel complexes and zinc complexes. Specific and preferable examples of the metal complex type anti-fading agent include compounds described in the patents cited in Research Disclosures No. 17643, VII-I to J, No. 15162, No. 18716, page 650, left column, No. 36544, page 527, No. 307105, page 872 and No. 15162 and compounds represented by the formulae of the typical compounds and included in the compound examples described in the JP-A No. 62-215272, page 127 to page 137.

Examples of the mildew-proofing agent include sodium dehydroacetate, sodium benzoate, sodium pyridinethione-1-oxide, ethyl p-hydroxybenzoate and 1,2-benzisothiazolin-3-one and its salts. These agents are preferably used in an amount of 0.02 to 1.00% by mass in the ink.

Examples of the pH regulator include inorganic bases such as hydroxides of alkali metals, e.g., lithium hydroxide and potassium hydroxide, carbonates, e.g., sodium carbonate and sodium bicarbonate, potassium acetate, sodium silicate and disodium phosphate and organic bases such as N-methyldiethanolamine and triethanolamine.

Examples of the surface tension regulator include nonionic, cationic or anionic surfactants. For example, the surfactants used for the aforementioned emulsification and dispersion may be used. The surfactants used here are preferably those having a solubility of 0.5% or more in water at 25° C.

Preferable examples of the dispersant and dispersion stabilizer include the aforementioned various cationic, anionic or nonionic surfactants.

Examples of the antifoaming agent include fluorine type or silicone type compounds and chelating agents represented by EDTAs.

The pH of the ink composition is preferably 6 to 10 and more preferably 7 to 10 from the viewpoint of improving preserving stability.

The surface tension of the ink composition is preferably 20 to 60 mN/m and more preferably 25 to 45 mN/m.

The viscosity of the ink composition is preferably 30 mPa.s or less and more preferably 20 mPa.s or less.

The ink composition of the invention may be preferably used in the following ink jet recording method of the invention.

Ink Jet Recording Method

The ink jet recording method of the invention is a method for recording of an ink image, comprising a step of discharging an ink composition against an ink image receiving material, and a step of fusing fine color particles contained in the ink composition onto the ink image receiving material by at least one of heat and pressure, wherein the ink composition is the aforementioned ink composition comprising the color fine particle dispersion containing the oil-soluble dye, the hydrophobic polymer having the glass transition temperature (Tg) of the hydrophobic polymer is 40° C. or more, and the high-boiling point organic solvent.

The aforementioned oil-soluble dye preferably contains at least one type selected from the group consisting of the compounds represented by the formula (I), the compounds represented by the formula (II), the compounds represented by the formula (Y-I), the compounds represented by the formula (M-I) and the compounds represented by the formula (C-I).

The image receiving material is preferably provided with at least one porous resin layer containing a thermoplastic hydrophobic polymer particle on a support. Also, in a preferred embodiment of the ink jet recording method of the invention, the color fine particle and the porous resin layer is treated under heating and/or under pressure, thereby the color fine particle is fused after forming an image on the image receiving material by discharging the ink composition against the image receiving material.

Here, it is preferable that the average particle diameter of the thermoplastic hydrophobic polymer particle on the image receiving material be larger than the average particle diameter of the color fine particle and that there be a relationship: 2<d₂/d₁<100 between the average particle diameter d₁ (μm) of the color fine particle and the average particle diameter d₂ (μm) of the thermoplastic hydrophobic polymer particle.

Particularly, the thermoplastic hydrophobic polymer on the image receiving material and the hydrophobic polymer contained in the color fine particle dispersion preferably have at least one structural unit (monomer unit) common to the both.

In the ink jet recording method of the invention, it is preferable to use the ink composition of the invention. Namely, it is preferable to use the ink composition containing the color fine particle comprising at least the oil-soluble dye, the hydrophobic polymer having a glass transition temperature (Tg) of 40° C. or more and the high-boiling point organic solvent.

It is to be noted that there is no particular limitation to the ink nozzle and the like which are used when recording using the ink jet recording method of the invention and the type of ink nozzle may be optionally selected according to the need.

Image Receiving Material

There is no particular limitation to the image receiving material and examples of the image receiving material include known recording materials, namely, standard paper and resin coated paper, for example, ink jet paper, films, electrophotographic common paper, clothes, glass, metals and ceramics described in JP-A Nos. 8-169172, 8-27693, 2-276670, 7-276789, 9-323475, 62-238783, 10-153989, 10-217473,10-235995, 10-337947, 10-217597, 10-337947 and the like.

In the invention, among the aforementioned image receiving materials, recording paper or recording films provided with an image receiving layer on a support are preferable and particularly image receiving materials provided with at least one porous resin layer containing a thermoplastic hydrophobic polymer particle on a support are preferable and image receiving materials provided with the porous resin layer on the upper part (on the side far from the support) of the image receiving layer are most preferable.

As the support, for example supports may be used which comprise chemical pulp such as LBKP and NBKP, mechanical pulp such as GP, PGW, RMP, TMP, CTMP, CMP and CGP or waste paper pulp such as DIP and are produced by blending currently known additives such as a pigment, binder, sizing agent, fixing agent, cationic agent and paper force enhancer and by using various apparatuses such as a Fourdrinier board machine and cylinder paper machine. Also, besides the above support materials, synthetic paper and plastic film sheets may be used.

The thickness of the support is about 10 to 250 μm and the basis weight of the support is preferably 10 to 250 g/m².

The support may be provided with the image receiving layer as it is or may be further provided with a back coat layer. Or the support may be provided with the image receiving layer and the back coat layer after a size press or anchor coat layer is formed using starch, polyvinyl alcohol or the like.

The support may be subjected to flattening treatment using a calendering apparatus such as a machine calender, TG calender or soft calender.

Among the aforementioned support materials, paper and plastic films both surfaces of which are laminated with a polyolefin (e.g., a polyethylene, polystyrene, polyethylene phthalate, polybutene and their copolymers) are more preferably used. It is preferable to add white pigments (e.g., titanium oxide and zinc oxide) or coloring dyes (e.g., cobalt blue, ultramarine blue and neodymium oxide) to the polyolefin.

The image receiving layer is provided on the support and contains a pigment and aqueous binder. The image receiving layer is preferably a layer constituted of pigments in general and the clearances between these pigment particles are utilized to absorb ink components.

As the pigment, white pigments are preferable. Preferable examples of the white pigments include inorganic pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide and zinc carbonate and organic pigments such as styrene type pigments, acryl type pigments, urea resins and melamine resins.

Among these white pigments, inorganic pigments are preferable, porous inorganic pigments provided with fine pores in the inside of the pigment itself are more preferable, synthetic amorphous silica, alumina, aluminum silicate or calcium carbonate having a large pore area are still more preferable and synthetic amorphous silica and alumina hydrate are particularly preferable.

As the above synthetic amorphous silica, any of silicic acid anhydride obtained by a dry production method and silicic acid hydrate obtained by a wet production method may be used and particularly silicic acid hydrate is preferably used.

The methods described in JP-A Nos. 2-276670 and 6-199034 may be applied to the production of the image receiving layer containing the alumina hydrate.

As to an example of the formulation, 11 mass parts (on a solid basis) of a polyvinyl alcohol and water are added to 100 mass parts of a boehmite sol which is synthesized from aluminum isopropoxide by a hydrolysis solation method and having a crystal thickness of 80 μm in the direction of the {020} plane and a secondary aggregated particle diameter of 1.5 to 4 μm to form a coating solution, which is then used to form a coating layer having a dry thickness of about 5 to 40 μm. As the coating layer produced in this manner, a transparent porous layer in which the pore diameter of the alumina hydrate porous layer is 50 to 60 mμ is obtained.

In another example of the formulation, water is added to 5 parts (solid) of an aggregation sol of a boehmite crystal (trade name: Cataloid AS-3, manufactured by Catalysts & Chemicals Industries Co., Ltd.) and 1 part (solid) of polyvinyl alcohol to produce a coating solution having a solid content of 10% and the coating solution is used to form a paint layer having a dry thickness of 5 to 40 μm.

Examples of the above aqueous binder include water-soluble polymers such as a polyvinyl alcohol, silanol-modified polyvinyl alcohol, starch, cationized starch, casein, gelatin, carboxymethyl cellulose, hydroxyethyl cellulose, polyvinylpyrrolidone, polyalkylene oxide and polyalkylene oxide derivatives and water-dispersible polymers such as a styrene butadiene latex and acryl emulsion.

These aqueous binders may be used either singly or in combinations of two or more. Among these binder materials, a polyvinyl alcohol and silanol-modified polyvinyl alcohol are preferable in light of adhesion to the above pigments and the anti-peeling characteristics of the image receiving layer.

The image receiving layer may contain a mordant, water-resistance promoter, light-resistance improver, surfactant and other additives besides the above pigments and aqueous binder.

The mordant is preferably placed in a steady state. For this, a polymer mordant is preferably used.

The polymer mordants are described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134 and 1-161236 and each specification of U.S. Pat. Nos. 2,484,430, 2,548,564, 3,148,061, 3,309,690, 4,115,124, 4,124,386, 4,193,800, 4,273,853, 4,282,305 and 4,450,224. An image receiving material containing the polymer mordant described in the JP-A No. 1-161236, pp.212-215 is particularly preferable. If the polymer mordant described in this publication is used, a high quality image is obtained and the light-resistance of an image is improved.

The above water-resistance promoter is effective to promote the water-resistance of an image. Preferable examples of the water-resistance promoter include cationic resins.

Examples of the cationic resins include a polyamidepolyamine epichlorohydrin, polyethyleneimine, polyaminesulfone, dimethyldiallylammonium chloride polymer and cationic polyacrylamide. Among these resins, a polyamidepolyamine epichlorohydrin is particularly preferable. The content of these cationic resins is preferably 1 to 15% by mass and particularly preferably 3 to 10% by mass based on the total solid of the image receiving layer.

Examples of the light-resistance improver include zinc sulfate, zinc oxide, hindered amine type antioxidants and benzotriazole type ultraviolet absorbers such as benzophenone. Among these compounds, zinc sulfate is particularly preferable.

The aforementioned surfactant functions as a coating adjuvant, peelability improver, sliding characteristics improver or antistatic agent. The surfactant is described in JP-A Nos. 62-173463 and 62-183457.

Organic fluoro compounds may be used in place of the surfactant. The organic fluoro compounds are preferably hydrophobic. Examples of the organic fluoro compound include fluorine type surfactants, oily fluorine type compounds (e.g., fluorine oil) and solid fluorine compounds (e.g., ethylene tetrafluoride resins). The organic fluoro compounds are described in JP-B No. 57-9053 (the 8th column to 17th column) and JP-A Nos. 61-20994 and 62-135826.

Examples of the aforementioned other additives include a pigment dispersant, thickener, antifoaming agent, dye, fluorescent whitener, antiseptic, pH regulator, matting agent and film hardener. The above image receiving layer may consist of one layer or two or more layers.

The thickness of the image receiving layer is preferably 10 to 50 μm and more preferably 20 to 40 μm.

The image receiving material used in the ink jet recording method of the invention is preferably provided with at least one porous resin layer containing a thermoplastic hydrophobic polymer particle on the support and most preferably has a structure in which the porous resin layer is provided on the upper part (on the side far from the support) of the image receiving layer.

The porous resin layer may be produced by applying a solution containing a thermoplastic hydrophobic polymer particle, namely a thermoplastic latex to the lower part layer (e.g., the image receiving layer) which has been already formed on the support, followed by drying according to a usual method.

Any raw material may be used as the thermoplastic latex contained in the porous resin layer (surface layer) as far as it can be formed into a transparent layer by heating treatment and/or treatment under pressure. Examples of the raw material of the thermoplastic latex include latexes of polyvinyl chloride, vinyl chloride/vinyl acetate copolymer, SBR, NBR, polystyrene, polyacrylate, polymethacrylic acid, styrene/acrylate copolymer, polyurethane, polyester and polyethylene types.

Examples of the raw material are not limited to the above resins and those obtained by chemically modifying these resins and those obtained by copolymerizing monomers may be used.

Also, a latex of the hydrophobic polymer contained in the color fine particle of the invention is used as the thermoplastic latex. These thermoplastic latexes may be used either singly or by mixing two or more according to the need.

The lowest film-forming temperature of the thermoplastic latex is preferably 40° C. to 150° C. and more preferably 50 to 130° C.

Here, the term “lowest film-forming temperature” means the lowest temperature at which the thermoplastic hydrophilic polymer particle can be melted and formed as a uniform film when it is formed a coating layer and heated.

The thermoplastic hydrophobic polymer particle in the invention has a volume average particle diameter of preferably 0.2 to 8 μm and more preferably 0.5 to 6 μm.

Also, when carrying out ink jet recording, it is important for developing the effect of the invention that the color fine particle in the ink composition enters into the voids of the porous resin layer containing the thermoplastic hydrophobic polymer particle in the image receiving material and is incorporated as a part of the formed layer when film-forming afterwards by heat treating and/or treating under pressure. It is therefore preferable that the average particle diameter of the thermoplastic hydrophobic polymer particle be larger than the average particle diameter of the color fine particle.

To mention specifically, the relationship between the average particle diameter d₁ (μm) of the color fine particle and the average particle diameter d₂ (μm) of the thermoplastic hydrophobic polymer particle is given by preferably the inequality: 2<d₂/d₁<100 and more preferably the inequality: 4<d₂/d₁<50.

Moreover, the particle diameter distribution of the thermoplastic hydrophobic polymer particles is preferably narrower to form voids. Specifically, the coefficient of variation in particle diameter is preferably less than40%, more preferably less than 30% and most preferably less than 20%.

The thermoplastic hydrophobic polymer particle may be prepared by an emulsion polymerization method in the above polymer synthesis method used for the preparation of the color fine particle in the ink composition of the invention.

As to another method, the thermoplastic hydrophobic polymer particle may also be prepared by dissolving a linear polymer in an organic solvent such as ethyl acetate and by emulsion-dispersing the polymer in water.

Also, the polymer species is preferably compatible with the hydrophobic polymer used in the ink composition of the invention. From this point, the thermoplastic hydrophobic polymer particle and the hydrophobic polymer contained in the ink composition respectively have at least one monomer unit as a structural unit common to both.

Also, the thermoplastic hydrophobic polymer particle may contain a plasticizer, a ultraviolet absorber and an anti-fading agent according to the need. Examples of the compounding method include a method of allowing a desired compound to coexist during polymerization or emulsion dispersion.

The thickness of the porous resin layer consisting of the thermoplastic latex is designed so as to obtain the function to be intended when film-forming after recording an image and is, for example, preferably about 1 to 20 μm and more preferably 3 to 15 μm.

The aforementioned image receiving material may be provided with a back coat layer and examples of components which may be added to the back coat layer include a white pigment, aqueous binder and other additives.

Examples of the white pigment contained in the back coat layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo boehmite, aluminum hydroxide, alumina, lithopone, zeolite, halloysite hydrate, magnesium carbonate and magnesium hydroxide and organic pigments such as styrene type plastic pigments, acryl type plastic pigments, polyethylenes, microcapsules, urea resins and melamine resins.

Examples of the aqueous binder contained in the back coat layer include water-soluble polymers such as a styrene/maleate copolymer, styrene/acrylate copolymer, polyvinyl alcohol, silanol-modified polyvinyl alcohol, starch, cationized starch, casein, gelatin, carboxymethyl cellulose, hydroxyethyl cellulose and polyvinylpyrrolidone and water-dispersible polymers such as a styrene butadiene latex and acryl emulsion.

Examples of the other components contained in the back coat layer include an antifoaming agent, foaming retarder, dye, fluorescent whitener, antiseptic and water-resistant agent.

A polymer latex may be added to the structural layers (including a back coat layer) in the image receiving material.

The above polymer latex is used for the purpose of improving film characteristics such as dimensional stabilization, curling prevention, prevention of adhesion and prevention of film cracking. There are descriptions concerning the polymer latex in JP-A No. 62-245258, 62-136648 and 62-110066. If a polymer latex having a low glass transition temperature (40° C. or less) is added to a layer containing a mordant, cracking and curling of the layer can be prevented. Also, if a polymer latex having a high glass transition temperature is added to the back coat layer, the curling of the layer can be prevented.

No particular limitation is imposed on the ink jet recording system and the ink jet recording system may be any of known systems including a charge control system jetting ink by making use of electrostatic induction force, drop-on-demand system (pressure pulse system) making use of the oscillation pressure of a piezo element, acoustic ink jet system in which electric signals are converted to acoustic beams, which are applied to ink to jet the ink by making use of the radiation pressure and thermal ink jet system in which ink is heated to form air cells to utilize the produced pressure.

It is to be noted that the ink jet recording system include a system emitting a large number of narrow streams of ink, called photo ink, system in which plural ink streams having substantially the same hue and differing in concentration to improve image quality and system using colorless and transparent ink.

### EXAMPLES

The present invention will be explained in more detail by way of examples, which are not intended to be limiting of the invention, in which all designations of “parts” and “%” indicate “parts by weight” and “weight %” respectively, unless otherwise noted.

### Example 1

Production Example 1: Preparation of a Color Fine Particle Dispersion (D-1)

A mixed solution consisting of 20 parts of ethyl acetate, 1.0 part of the following oil-soluble dye (a), 3.0 parts of a hydrophobic polymer (P-2: poly(t-butylacrylate), Tg=107° C.) and 0.5 parts of the following high-boiling point organic solvent (b) was prepared. A mixed solution consisting of 25 parts of water and 0.5 parts of sodium di(2-ethylhexyl)sulfosuccinate was prepared separately. The above two mixed solutions were blended and emulsion-dispersed using a homogenizer, followed by removing ethyl acetate to obtain a color fine particle dispersion having a solid content of 15.0%. The particle diameter of the color fine particle in the color fine particle dispersion was measured using a particle diameter distribution measuring instrument (trade name: LB-500, manufactured by HORIBA, Ltd.), to find that it was 80 nm in terms of volume average particle diameter. This color fine particle dispersion is hereinafter abbreviated as a color fine particle dispersion (D-1).

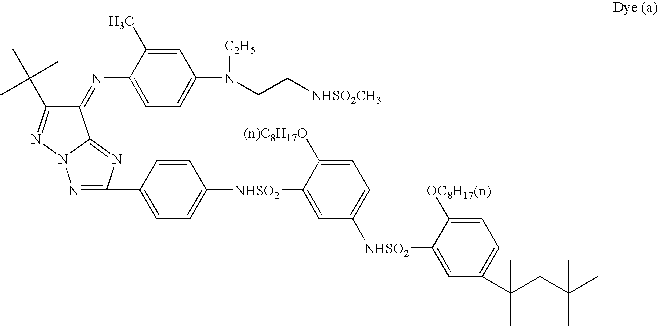

High-boiling Point Organic Solvent (b)

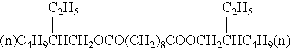

Production Example 2: preparation of a color fine particle dispersion (D-2)

A color fine particle dispersion (D-2) was prepared in the same manner as in Production Example 1 except that the hydrophobic polymer (P-2) was altered to a hydrophobic polymer (P-8; poly(benzylmethacrylate), Tg=54° C.) in Production Example 1. The particle diameter of the fine particle in this color fine particle dispersion (D-2) was 85 nm in volume average.

Production Example 3: Preparation of a Color Fine Particle Dispersion (D-3)

A color fine particle dispersion (D-3) was prepared in the same manner as in Production Example 1 except that the hydrophobic polymer (P-2) was altered to a hydrophobic polymer (P-11; poly(ethylmethacrylate), Tg=65° C.) in Production Example 1. The particle diameter of the fine particle in this color fine particle dispersion (D-3) was 85 nm in volume average.

Production Example 4: Preparation of a Color Fine Particle Dispersion (D-4)

A color fine particle dispersion (D-4) was prepared in the same manner as in Production Example 1 except that the hydrophobic polymer (P-2) was altered to a hydrophobic polymer (P-15; polystyrene, Tg=100° C.) in Production Example 1. The particle diameter of the fine particle in this color fine particle dispersion (D-4) was 80 nm in volume average. Production Examples 5 to 7: preparation of color fine particle dispersions (D-5 to D-7)

Color fine particle dispersions (D-5 to D-7) were prepared in the same manner as in Production Example 1 except that the oil-soluble dye (a) was altered to the following oil-soluble dyes (b to d) in Production Example 1. The particle diameter of the fine particles in these color fine particle dispersions (D-5 to D-7) were 90 nm, 80 nm and 85 nm in volume average respectively.

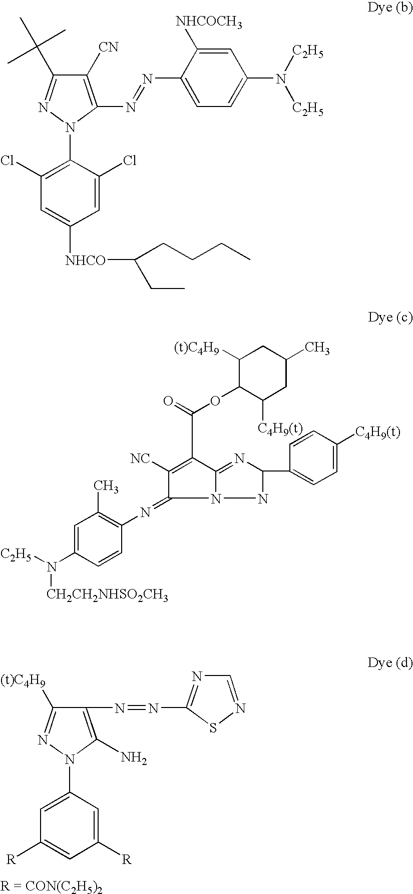

### Example 2

Production of an Ink Sample 01

The following raw materials were mixed and the mixture was filtered using a 0.45 μm filter to prepare an aqueous ink jet recording ink (01),

| | | |
|---|---|---|
| Color fine particle dispersion (D-1) | 60 | parts |
| Diethylene glycol | 5 | parts |
| Glycerol | 15 | parts |
| Diethanolamine | 1 | part |

One-terminal 2-butyl octanate of polyethylene glycol (average repeat number of ethylene oxides: 10) 1 part

Water amount to be a total of 100 parts

Production of Ink Samples 02 to 07

Aqueous ink jet recording inks (02 to 07) were produced in the same manner as in the production of the ink (01) except that the color fine particle dispersion (D-1) was replaced by the color fine particle dispersions (D-2 to D-7) in the production of the ink (01).

Production of Comparative Ink Samples 08 and 09

Color fine particle dispersions (D-8 and D-9) were prepared in the same manner as in Production Examples 1 and 5 except that 3.0 parts of the hydrophobic polymer (P-2; poly(t-butylacrylate) was excluded in Production Examples 1 and 6.

Then, aqueous ink jet recording inks (08 and 09) were produced in the same manner as in the production of the ink (01) except that the color fine particle dispersion (D-1) was replaced by the color fine particle dispersions (D-8 to D-9) in the production of the ink (01).

Preparation of a comparative ink sample 10

A commercially available magenta ink (trade name: PM950C, manufactured by Seiko Epson Corporation) was used as an ink jet recording ink (10).

Image Recording and Evaluation

The inks (01 to 10) produced above were respectively filled in the cartridge of an ink jet recording printer (trade name: PM-890C, manufactured by Seiko Epson Corporation). Using this printer, an image was recorded in a PPC paper and an ink jet recording paper (trade name: Photo Gloss Paper EX, manufactured by Fuji Photo Film Co., Ltd.) to make the following evaluation tests. The results of the evaluations are shown in the following Table 1.

Evaluation of Printing Performance

The cartridge was set to the printer and it was confirmed that ink was jetted from all nozzles. Then, an image was printed on 30 sheets of A4 paper to evaluate printing disorders according to the following standard.

A: Printing disorders and a non-jetting phenomenon did not occur from the start to end of printing.

B: Printing disorders and a non-jetting phenomenon sometimes occurred from the start to end of printing.

C: Printing disorders and a non-jetting phenomenon occurred considerably frequently.

Evaluation of paper dependency

The color tone of an image formed on the photo glossy paper was compared with that of an image formed on the PPC paper to evaluate a difference in color tone in the following three grades: A: the case where there is almost no difference between the both images, B: the case where there is a little difference between the both images and C: the case where there is a large difference between the both images.

Evaluation of water resistance

The photo glossy paper on which an image was formed was dried at ambient temperature for about one hour. Then, the glossy paper was dipped in water for 30 seconds and then air-dried at ambient temperature to observe spreading. The evaluation was made in the following three grades: A: no spreading was observed, B: slight spreading was observed and C: a lot of spreading was observed.

Evaluation of light fastness

The photo glossy paper on which an image was formed was irradiated with xenon light (85000 Lx) for 10 days by using a weather meter (trade name: ATLAS CI65, manufactured by ATLAS) to measure image densities before and after the irradiation with the xenon light by using a reflection densitometer (trade name: 310 TR, manufactured by X-Rite, Incorporated) to evaluate these densities for a dye residual rate. This reflection density was measured at three points: 1, 1.5 and 2.0.

The evaluation was made in the following grades: A: the case where the dye residual rate was 80% or more, B: the case where the dye residual rate was less than 80% and 70% or more and C: the case where the dye residual rate was less than 70% at any density.

Evaluation of ozone resistance

The ozone resistance was evaluated in the following manner: the sample was stored for 3 days under the condition of an ozone density of 5.0 ppm to measure the image densities of the sample before and after the sample was stored by using an instrument (trade name: 310 TR, manufactured by X-Rite, Incorporated) and then to calculate the residual rate of a colorant. The evaluation was made in the following five grades: A: the case where the dye residual rate was 95% or more, B: the case where the dye residual rate was 95 to 90%, C: the case where the dye residual rate was 90 to 80%, D: the case where the dye residual rate was 80 to 50% and E: the case where the dye residual rate was less than 50%.

TABLE 1

| | Printing | Paper | Water | Light | Ozone |
|---|---|---|---|---|---|
| | performance | dependency | resistance | fastness | resistance |
| Ink of Example 01 | A | A | A | A | A |
| Ink of Example 02 | A | A | A | A | A |
| Ink of Example 03 | A | A | A | A | A |
| lnk of Example 04 | A | A | A | A | A |
| Ink of Example 05 | A | A | A | A | A |
| Ink of ExampLe 06 | A | A | A | A | A |
| Ink of Example 07 | A | A | A | A | A |
| Ink of Comparative | C | A | A | A | A |
| Example 08 | | | | | |
| Ink of Comparative | C | A | A | A | A |
| Example 09 | | | | | |
| Ink of Comparative | A | B | B | B | C |
| Example 10 | | | | | |

As is clear from the above results, the ink jet recording inks of Examples had excellent printing aptitude, color developing ability and color tone, was independent on paper and was superior in water resistance, light fastness and ozone resistance.

Evaluation of preserving stability of ink

As regards the preserving stability of the ink composition, the following evaluation was made.

First, the coefficient of variation in the particle diameter of each color fine particle contained in the ink compositions (01 to 07) of the invention was less than 45% in both of the condition just after preparing the ink composition and the condition after time passed. On the other hand, in the case of the comparative ink compositions (08 and 09) other than the ink compositions of the invention, the coefficient of variation in the particle diameter of each color fine particle contained in the comparative ink compositions was 45% or more in the condition just after preparing the ink composition and/or the condition after time passed.

Next, each sample of the above ink compositions was sealed in a glass bottle and stored at 0° C., 20° C., 40° C. and 60° C. for one month. Then, a change in the diameter of each particle, the occurrence of precipitates and a change in solution physical properties were measured to evaluate the preservation stability. The results of the evaluation are shown in Table 2. In the overall evaluation of the preserving stability, “⊚”, “∘”, “Δ”, and “x” in the table mean “excellent”, “good”, “slightly inferior” and “inferior” respectively. “xx” shows the case where the ink itself was not prepared because of dispersion inferior. The change in particle diameter is shown by the results of the particles stored at 60° C.

TABLE 2

| | Preserving stability | | | |
|---|---|---|---|---|
| | | | | Overall evaluation |
| | Average particle diameter (mm) | | | precipitation, |
| Type of ink | When 0 day | After 40 days | Coefficient of | properties |
| composition | passed d₀ | passed d₄₀ | variation %*⁾ | and the like |
| Ink of Example 01 | 80 | 84 | 105 | ⊚ |
| Ink of Example 02 | 85 | 89 | 105 | ⊚ |
| Ink of Example 03 | 85 | 82 | 96 | ⊚ |
| Ink of Example 04 | 80 | 79 | 99 | ⊚ |
| Ink of Example 05 | 90 | 93 | 103 | ⊚ |
| Ink of Example 06 | 80 | 78 | 98 | ⊚ |
| Ink of Example 07 | 85 | 88 | 104 | ⊚ |
| Ink of Comparative | 90 | 325 | 361 | Slightly separated |
| Example 08 | | | | |
| Ink of Comparative | 85 | 292 | 344 | Slightly separated |
| Example 09 | | | | |

*⁾Coefficient of variation (%) = 100 × (d₄₀ − d₀)/d₀

As shown in Table 2, it was confirmed that in the ink composition of the invention, coarsening of the particle diameter of the color fine particle, occurrence of precipitates and change in solution physical properties, which were causes of deteriorated ink-discharging characteristics, were decreased and therefore an ink composition having excellent preserving stability was obtained.

The invention can provide an ink jet recording ink which has good continuous printing characteristics, is free from clogging at the tip of a nozzle and is independent on paper when printing using the nozzle, and is also superior in water resistance, scratching resistance, light fastness and ozone resistance and also provides an ink jet recording method.

What is claimed is:

1. An ink composition comprising a color fine particle dispersion containing an oil-soluble dye, a hydrophobic polymer, and a high-boiling point organic solvent, wherein the glass transition temperature (Tg) of the hydrophobic polymer is 40° C. or more.

2. An ink composition according to claim 1, wherein an average particle diameter of the color fine particles is 0.01 to 0.5 μm and has a specific gravity of 0.9 to 1.2.

3. An ink composition according to claim 1, wherein the solubility of water in the high boiling point organic solvent at 25° C. is 4 g or less.

4. An ink composition according to claim 1, wherein an equilibrium moisture content of the hydrophobic polymer at 25° C. under a relative humidity of 60% RH is 3% or less.

5. An ink composition according to claim 1, wherein the oil-soluble dye contains at least one compound selected from the group consisting of compounds represented by the following formula (I), compounds represented by the following formula (II), compounds represented by the following formula (Y-I), compounds represented by the following formula (M-I) and compounds represented by the following formula (C-I): 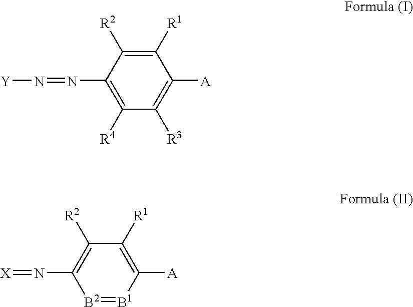
wherein R¹, R², R³ and R⁴ each independently represents a hydrogen atom, a halogen atom, an aliphatic group, an aromatic group, a heterocyclic group, a cyano group, a hydroxyl group, a nitro group, an amino group, an alkylamino group, an alkoxy group, an aryloxy group, an amide group, an arylamino group, a ureide group, a sulfamoylamino group, an alkylthio group, an arylthio group, an alkoxycarbonylamino group, a sulfonamide group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a sulfinyl group, a phosphoryl group, an acyl group, a carboxyl group or a sulfo group; A represents —NR⁵R⁶ or a hydroxyl group; R⁵ and R⁶ each independently represents a hydrogen atom, an aliphatic group, an aromatic group or a heterocyclic group, and R⁵ and R⁶ may be combined with each other to form a ring; B¹ represents ═C(R³)— or ═N—; B² represents —C(R⁴)═ or —N═; and at least one pair among pairs of R¹ and R⁵, R³ and R⁶, and R¹ and R² may respectively be combined with each other to form an aromatic ring or a heterocyclic ring;
A—N═N—B Formula (Y-I)
wherein A and B each independently represents a heterocyclic group which may be substituted; 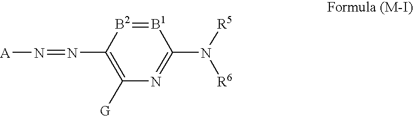
wherein A represents a residue of a five-membered heterocyclic diazo component (A-NH₂); as regards B¹ and B², when B¹ represents ═CR¹—, B² represents —CR²═, and when one of B¹ and B² represents a nitrogen atom, the other represents ═CR¹— or —CR²═; R⁵ and R⁶ each independently represents a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group or a sulfamoyl group where each group may further have a substituent; G, R¹ and R² each independently represents a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group substituted with an alkyl group, aryl group or heterocyclic group, an acylamino group, a ureide group, a sulfamoylamino group, an alkoxycarbonylamino group, an aryloxycarbonylamino group, an alkylarylsulfonylamino group, an arylsulfonylamino group, an aryloxycarbonylamino group, a nitro group, an alkylthio group, an arylthio group, an alkylsulfonyl group, an arylsulfonyl group, an alkylsulfinyl group, an arylsulfinyl group, a sulfamoyl group, a sulfo group or a heterocyclic thio group, where each group may be further substituted; and R¹ and R⁵ or R⁵ and R⁶ may be combined with each other to form a five- or six-membered ring; 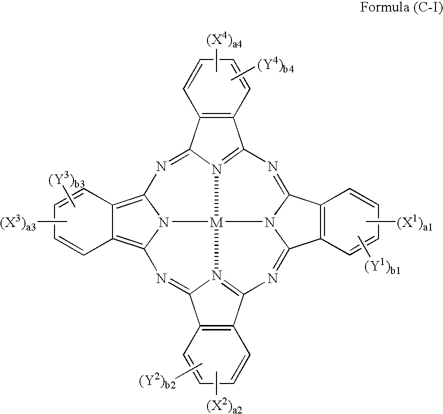
wherein X¹, X², X³ and X⁴ each independently represents —SO—Z¹—, SO₂—Z¹ or —SO₂NR²¹R²²; Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group or a substituted or unsubstituted heterocyclic group; R²¹ and R²² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group or a substituted or unsubstituted heterocyclic group; Y¹, Y², Y³ and Y4 each independently represents a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureide group, a sulfamoylamino group, an alkylthio group, an arylthio group, an alkoxycarbonylamino group, a sulfonamide group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a phosphoryl group, an acyl group, a carboxyl group or a sulfo group, where each group may have a substituent; a¹ to a⁴ and b¹ to b⁴ each independently satisfies the following relations: a¹+b¹=4, a²+b²=4, a³+b³=4, a⁴+b⁴=4 and a¹+a²+a³+a⁴≧2 and represents an integer from 0 to 4, where when a¹ to a⁴ and b¹ to b⁴ each denote an integer of 2 or more, a plurality of X¹s to X⁴s and Y¹s to Y⁴s may respectively be the same or different; and M denotes a hydrogen atom, a metal element or its oxide, hydroxide or halide.

6. An ink jet recording method comprising:
discharging an ink composition against an ink image receiving material; and
fusing fine color particles contained in the ink composition onto the ink image receiving material by at least one of heat and pressure, wherein the ink composition is the ink composition comprising a color fine particle dispersion containing an oil-soluble dye, a hydrophobic polymer, and a high-boiling point organic solvent, wherein the glass transition temperature (Tg) of the hydrophobic polymer is 40° C. or more.

7. An ink jet recording method according to claim 6, wherein the ink image receiving material is formed on a support and contains at least one porous resin layer containing thermoplastic hydrophobic polymer particles, and the average particle diameter of the thermoplastic hydrophobic polymer particles is larger than the average particle diameter of the fine color particles.

8. An ink jet recording method according to claim 7, wherein the average particle diameter d₁ (μm) of the fine color particles and the average particle diameter d₂ (μm) of the thermoplastic hydrophobic polymer particles satisfy the following relation: 2<d₂/d₁<100.

9. An ink jet recording method according to claim 7, wherein the thermoplastic hydrophobic polymer particles on the ink image receiving material and the hydrophobic polymer contained in the fine color particle dispersion respectively have at least one monomer unit as a structural unit common to both.
